(19) United States
(12) Patent Application Publication
(10) Pub. No.: US 2024/0231905 A1
(43) Pub. Date: Jul. 11, 2024

(54) ELECTRONIC SYSTEM AND ELECTRONIC CONTROL DEVICE

(71) Applicant: HITACHI ASTEMO, LTD., Hitachinaka-shi, Ibaraki (JP)

(72) Inventors: Masashi MIZOGUCHI, Chiyoda-ku, Tokyo (JP); Takashi MURAKAMI, Hitachinaka-shi, Ibaraki (JP); Kazuyoshi SERIZAWA, Hitachinaka-shi, Ibaraki (JP); Yukinori ASADA, Hitachinaka-shi, Ibaraki (JP); Takeshi FUKUDA, Chiyoda-ku, Tokyo (JP); Tomohito EBINA, Hitachinaka-shi, Ibaraki (JP)

(73) Assignee: HITACHI ASTEMO, LTD., Hitachinaka-shi, Ibaraki (JP)

(21) Appl. No.: 18/290,580

(22) PCT Filed: Feb. 3, 2022
(86) PCT No.: PCT/JP2022/004244

§ 371 Date: Jan. 19, 2024

(30) Foreign Application Priority Data
Sep. 2, 2021 (JP) 2021-143221

(51) Int. Cl. G06F 9/48

(52) U.S. Cl. CPC G06F 9/4887

(57) ABSTRACT

In an electronic system, a plurality of task processing units that processes assigned tasks are connected via a network. Each of the plurality of task processing units includes a task activation unit that activates and executes the task, and third task processing in a third task processing unit uses at least a processing result of a first task in a first task processing unit or a processing result of a second task in a second task processing unit preceding the third task processing, and periodically executes a series of processing from the preceding first task processing or the second task processing to the third task processing at predetermined time intervals.

### TECHNICAL FIELD

The present invention relates to an electronic system and an electronic control device thereof.

### BACKGROUND ART

In order to improve utilization efficiency of a central processing unit (CPU) mounted on an in-vehicle electronic control device (ECU), it is considered effective to dynamically change scheduling of a task to be calculated in each CPU according to a processing load or the like. Therefore, PTL 1 discloses a technology for providing a distributed control method and a device capable of guaranteeing a response time and a deadline condition required by distributed control without imposing an excessive burden on a designer of a distributed control system. PTL 1 discloses that a message transmission right is preferentially allocated to each transmittable message from a message having a smaller time margin based on the time margin for distributed control to which the message belongs.

### CITATION LIST

### Patent Literature

PTL 1: JP 2003-298599 A

### SUMMARY OF INVENTION

### Technical Problem

In the technique of PTL 1, regarding message transmission with a deadline, the transmission priority is changed to be higher than that of message transmission with a short deadline. As a result, when the processing load of the CPU is large and the message transmission is delayed, it is expected that the transmission timing of each message is dynamically changed and the transmission deadline of each message is complied with. However, the timing at which each message is transmitted is determined by the processing load of the CPU, the number of messages to be transmitted, the amount of data, and the like. For this reason, there are an infinite number of verification patterns related to message transmission, and it is difficult to verify the operation in advance whether the deadline is actually complied with.

By the way, a scheduling technique called logical execution time (LET) is known. In the LET, timing at which each task accesses a global memory is fixed. An interval between fixed read and write when the global memory is accessed at the time of task processing is referred to as an “interval”. Each task reads a necessary variable from the global memory at the beginning of the interval and copies the variable to the local memory (Read task (R task)), and writes an operation result from the local memory to the global memory at the end of the interval (Write task (W task)). The calculation (Execute task (E task)) of each task may be executed at any timing in the interval. That is, the execution timing of the E task can be arbitrarily changed within the interval.

As a result, even when the calculation timing of the E task in the local memory deviates due to the influence of the CPU processing load or the like, it is guaranteed that the behavior of the microcomputer or the ECU does not change as long as the fixing of the read and write timings to the global memory is observed.

The conventional LET is applicable only to the inside of the same microcomputer, but it is considered that the LET can be extended between the ECUs as long as the time required for communication between the ECUs is guaranteed. However, in the LET, in order to comply with fixing of read and write timings to the global memory, it is necessary to design an interval at a time sufficiently longer than the execution time of the E task calculated in the local memory. This may often cause a reduction in CPU utilization efficiency.

In view of the above circumstances, an object of the present invention is to improve utilization efficiency of an arithmetic device such as a CPU by dynamically changing task scheduling in accordance with a situation of a processing load.

### Solution to Problem

In order to solve the above problem, an electronic system according to an aspect of the present invention is an electronic system in which a plurality of task processing units that processes assigned tasks are connected via a network.

Each of the plurality of task processing units includes a task activation unit that activates and executes the task, and third task processing in a third task processing unit uses at least a processing result of a first task in a first task processing unit or a processing result of a second task in a second task processing unit preceding the third task processing, and periodically executes a series of processing from the preceding first task processing or the second task processing to the third task processing at predetermined time intervals.

### Advantageous Effects of Invention

According to at least one aspect of the present invention, task scheduling (execution timing) is dynamically changed in accordance with a state of a processing load to improve utilization efficiency of a task processing unit. In addition, by setting the series of processes after the change of the task scheduling within a predetermined time interval, it is possible to ensure that the scheduling change does not affect other processing.

Problems, configurations, and effects other than those described above will be clarified by the following description of embodiments.

### BRIEF DESCRIPTION OF DRAWINGS

FIG. 1 is a diagram illustrating an overall configuration example of an electronic system according to a first embodiment of the present invention.

FIG. 2 is a diagram illustrating a hardware configuration example of each electronic control device included in the electronic system according to the first embodiment of the present invention.

FIG. 3 is a flowchart illustrating an outline of a processing procedure in a third electronic control device (automatic driving ECU) according to the first embodiment of the present invention.

FIG. 4 is a diagram illustrating an example of a camera risk map according to the first embodiment of the present invention.

FIG. 5 is a diagram illustrating an example of a LIDAR risk map according to the first embodiment of the present invention.

FIG. 6 is a diagram illustrating an example of a superimposed risk map according to the first embodiment of the present invention.

FIG. 7 is a diagram illustrating an example of a control cycle of the electronic system according to the first embodiment of the present invention.

FIG. 8 is a diagram illustrating an example in which processing from data acquisition to trajectory generation according to the first embodiment of the present invention is mapped to a task.

FIG. 9 is a diagram illustrating an example before a task is made to correspond to LET.

FIG. 10 is a diagram illustrating an example after a task according to the first embodiment of the present invention is made to correspond to LET.

FIG. 11 is a diagram for explaining intervals in a normal LET.

FIG. 12 is a diagram for explaining a reference time (budget) and a time margin (margin) according to the first embodiment of the present invention.

FIG. 13 is an example of a timing chart illustrating extension of an interval and sharing of a margin according to the first embodiment of the present invention.

FIG. 14 is an example of an improved version timing chart in view of the processing order change according to the first embodiment of the present invention.

FIG. 15 is an example of a timing chart illustrating a processing delay allowed to the maximum in a case where the processing order change according to the first embodiment of the present invention is not performed.

FIG. 16 is an example of a timing chart illustrating the processing delay allowed to the maximum in a case where the processing order change according to the first embodiment of the present invention is performed.

FIG. 17 is a flowchart for determining whether it is necessary to perform the change of the processing order according to the first embodiment of the present invention.

FIG. 18 is a block diagram illustrating a scheduling function of each electronic control device according to the first embodiment of the present invention.

FIG. 19 is a diagram illustrating an example of a method of calculating an estimated processing time of a camera object detection task (E task) in a first electronic control device (camera ECU) according to the first embodiment of the present invention.

FIG. 20 is a diagram illustrating an example of processing time excess task information transmitted from the first electronic control device (camera ECU) to a third electronic control device (automatic driving ECU) according to the first embodiment of the present invention.

FIG. 21 is a diagram illustrating, by a source code, a method of activating a task in the third electronic control device (automatic driving ECU) according to the first embodiment of the present invention.

FIG. 22 is a flowchart for determining whether it is necessary to perform change of a processing order according to a second embodiment of the present invention.

FIG. 23 is a diagram illustrating timing at which processing is performed by each electronic control device in a case where processing according to the second embodiment of the present invention is skipped.

FIG. 24 is a diagram illustrating, by a source code, a method of activating a task in a third electronic control device (automatic driving ECU) according to a second embodiment of the present invention.

FIG. 25 is a flowchart for determining whether it is necessary to perform change of a processing order according to a third embodiment of the present invention.

FIG. 26 is a diagram illustrating timing at which processing is performed by each electronic control device in a case where processing according to the third embodiment of the present invention is changed.

FIG. 27 is a diagram illustrating, by a source code, a method of activating a task in a third electronic control device (automatic driving ECU) according to a third embodiment of the present invention.

FIG. 28 is a flowchart for determining whether it is necessary to perform change of a processing order according to a fourth embodiment of the present invention.

FIG. 29 is a diagram illustrating timing at which processing is performed by each electronic control device in a case where the processing according to the fourth embodiment of the present invention is changed.

FIG. 30 is a diagram illustrating, by a source code, a method of activating a task in a third electronic control device (automatic driving ECU) according to the fourth embodiment of the present invention.

FIG. 31 is a diagram illustrating an overall configuration example of an electronic system according to a sixth embodiment of the present invention.

FIG. 32 is a diagram illustrating an overall configuration example of an electronic system according to a seventh embodiment of the present invention.

### DESCRIPTION OF EMBODIMENTS

The present invention relates to an electronic system, and more particularly to a vehicle control system in which a plurality of electronic control devices (ECU) are connected via a network. Hereinafter, examples of modes for carrying out the present invention will be described with reference to the accompanying drawings. In the present specification and the accompanying drawings, components having substantially the same function or configuration are denoted by the same reference numerals, and redundant description is omitted.

### First Embodiment

First, an electronic system including a plurality of electronic control devices according to a first embodiment of the present invention will be described.

### <Overall Configuration of Electronic System>

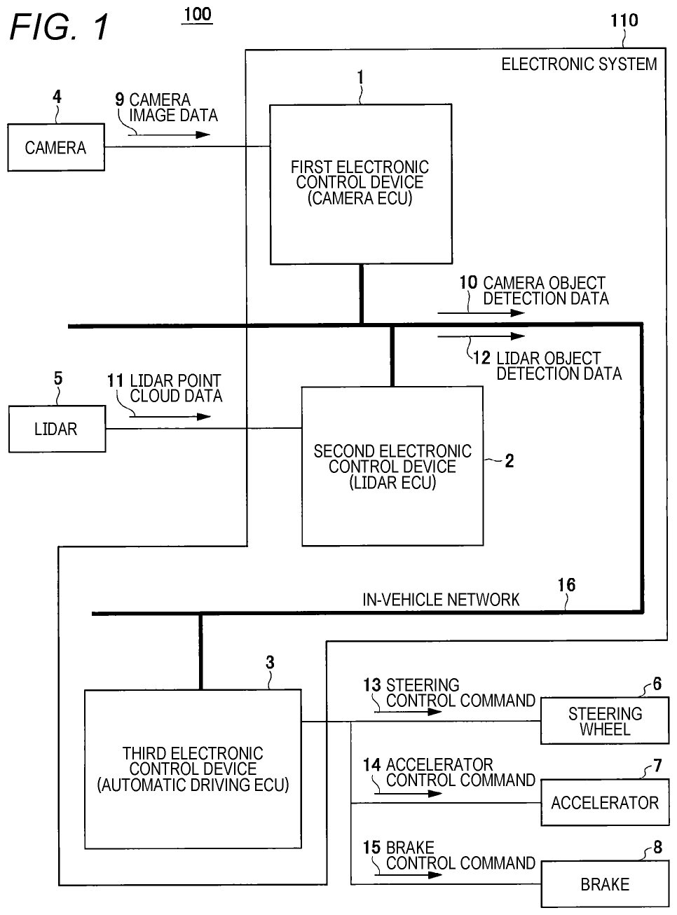

An electronic system according to a first embodiment of the present invention will be described with reference to FIG. 1.

FIG. 1 is a diagram illustrating an overall configuration example of an electronic system according to a first embodiment of the present invention.

An illustrated vehicle 100 includes a sensor (sensing device) including a camera 4 and a LIDAR 5, an electronic system 110, a steering wheel 6, an accelerator 7, and a brake 8. The sensors and mechanisms described in FIG. 1 merely illustrate a part of the vehicle 100.

The electronic system 110 receives camera image data 9 and LIDAR point cloud data 11 from the camera 4 and the LIDAR 5, respectively. The electronic system 110 has a role of outputting a steering control command 13, an accelerator control command 14, and a brake control command 15 to the respective actuators of the steering wheel 6, the accelerator 7, and the brake 8 based on these data.

The electronic system 110 internally includes a camera ECU 1 as a first electronic control device, a LIDAR ECU 2 as a second electronic control device, and an automatic driving ECU 3 as a third electronic control device. The three electronic control devices are communicably connected to each other by an in-vehicle network 16. The first to third electronic control devices are examples of first to third task processing units.

In the present embodiment, the in-vehicle network 16 is configured by a communication scheme in which the times of all the electronic control devices connected to the in-vehicle network 16 are synchronized and data transmission within a certain period of time can be guaranteed. As an example of such a communication scheme, there is a known time sensitive network (TSN), but the communication scheme applicable to the in-vehicle network 16 of the present invention is not limited thereto.

The first electronic control device (camera ECU 1) receives the camera image data 9 from the camera 4, generates camera object detection data, and transmits the camera object detection data 10 to the third electronic control device (automatic driving ECU 3) using the in-vehicle network 16. The camera object detection data 10 includes information such as the type, position (coordinates), and ID (label information) of the detected object. Since the internal logic of the first electronic control device (camera ECU 1) and the data format of the camera object detection data 10 are not directly related to the present invention, the illustration thereof is omitted.

The second electronic control device (LIDAR ECU 2) receives the LIDAR point cloud data 11 from the LIDAR 5, generates LIDAR object detection data 12, and transmits the generated LIDAR object detection data to the third electronic control device (automatic driving ECU 3) using the in-vehicle network 16. The LIDAR object detection data 12 includes information such as the type, position (coordinates), and ID (label information) of the detected object. The internal logic of the second electronic control device (LIDAR ECU 2) and the data format of the LIDAR object detection data 12 are not directly related to the present invention and thus the illustration thereof is omitted.

The third electronic control device (automatic driving ECU 3) receives the camera object detection data 10 from the camera ECU 1 and the LIDAR object detection data 12 from the LIDAR ECU 2. Then, the third electronic control device (automatic driving ECU 3) generates a traveling trajectory by analyzing the camera object detection data 10 and the LIDAR object detection data 12, and generates the steering control command 13, the accelerator control command 14, and the brake control command 15 for realizing the traveling trajectory.

The function given to each electronic control device (ECU) is an example, and the present invention is not limited thereto. That is, it should be noted that the present invention is applicable regardless of the type of sensor, the number of ECUs, and the application installed in the ECU.

### <Hardware Configuration of Electronic Control Device>

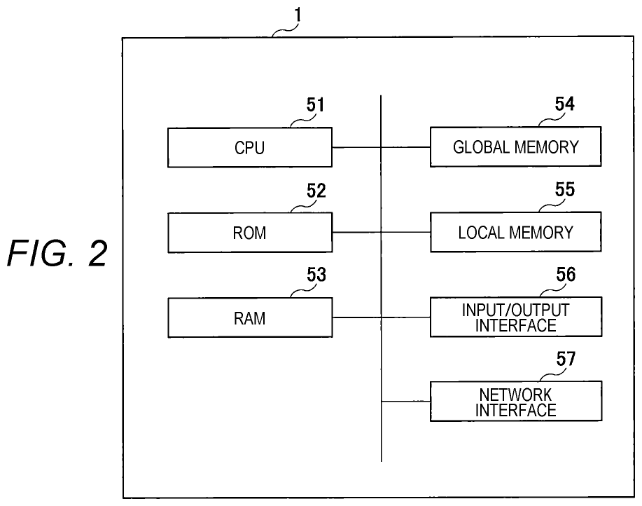

FIG. 2 is a diagram illustrating a hardware configuration example of each electronic control device included in the electronic system 110. Here, a hardware configuration will be described using the camera ECU 1 as an example.

The illustrated camera ECU 1 includes a central processing unit (CPU) 51, a read only memory (ROM) 52, a random access memory (RAM) 53, a global memory 54, a local memory 55, an input/output interface 56, and a network interface 57. The pieces of hardware (blocks) are connected to each other via a system bus. These pieces of hardware (blocks) constitute a computer system (an example of a computer). The CPU 51 (CPU core) reads a software program from the ROM 52, develops the program in the RAM 53, and executes the program, thereby implementing the function of the camera ECU 1.

The CPU 51 has a known timer function. Although the CPU is used as the processing unit, another processing unit such as a micro processing unit (MPU) may be used.

Each of the global memory 54 and the local memory 55 is a memory used in the LET and includes a nonvolatile semiconductor memory. For example, the control program may be stored in the global memory 54 or the local memory 55 including a semiconductor memory or the like. Note that the global memory region and the local memory region may be realized by making address regions different in one memory. In addition, a referable address in the memory may be set for each of the global memory area and the local memory area by a programming language such as C language.

The input/output interface 56 is an interface that communicates signals and data with each sensor and each actuator. The ECU includes an analog/digital (A/D) converter (not illustrated) that processes input/output signals of each sensor, a driver circuit, and the like. The input/output interface 56 may also serve as the A/D converter or the driver circuit.

The network interface 57 is configured to be able to transmit and receive various data to and from other ECUs connected to the in-vehicle network 16 via the in-vehicle network 16 to which the terminals are connected.

The same applies to the hardware configurations of the LIDAR ECU 2 and the automatic driving ECU 3. In the LIDAR ECU 2, the CPU 51 executes a program stored in the ROM 52 to implement the function of the LIDAR ECU 2. In addition, in the automatic driving ECU 3, the CPU 51 executes a program stored in the ROM 52, thereby implementing the function of the automatic driving ECU 3. Note that these programs may be stored in the global memory 54 or the local memory 55.

### <Third Electronic Control Device (Automatic Driving ECU)>

Here, the function of the third electronic control device (automatic driving ECU 3) will be described in more detail.

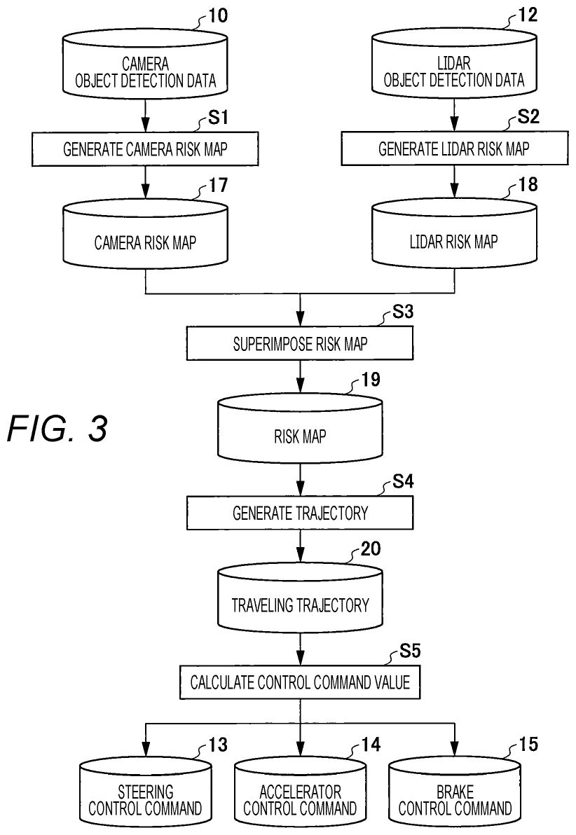

FIG. 3 is a flowchart illustrating an outline of a processing procedure in the third electronic control device (automatic driving ECU 3) according to the first embodiment.

In Step S1, the automatic driving ECU 3 generates the camera risk map 17 based on the camera object detection data 10.

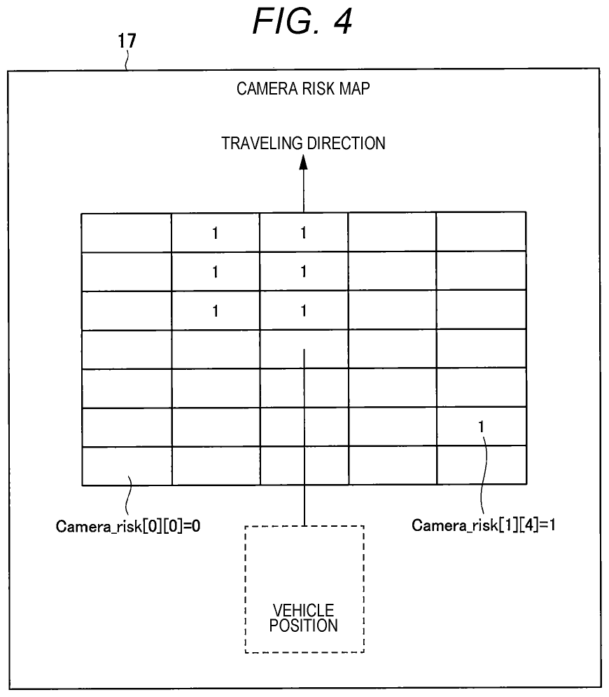

FIG. 4 is a diagram illustrating an example of the camera risk map 17 according to the first embodiment.

The camera risk map 17 is a two-dimensional array that stores integer values, divides a front region (imaging region in a traveling direction) of the vehicle 100 into grids, and substitutes 1 to a grid (array element) in which the presence of an object is detected by the camera object detection data 10 and 0 to the other grids (array elements) (description of 0 is omitted in FIG. 4). For example, since no object is detected in the lower left corner of the grid, 0 is substituted for Camera_risk[0] [0]. Furthermore, since an object is detected in a grid moved in the traveling direction by one grid (one grid in the upward direction in the drawing) from the lower right corner of the grid, 1 is substituted for Camera_risk[1] [4].

The description returns to FIG. 3. In Step S2, the automatic driving ECU 3 generates a LIDAR risk map 18 based on the LIDAR object detection data 12.

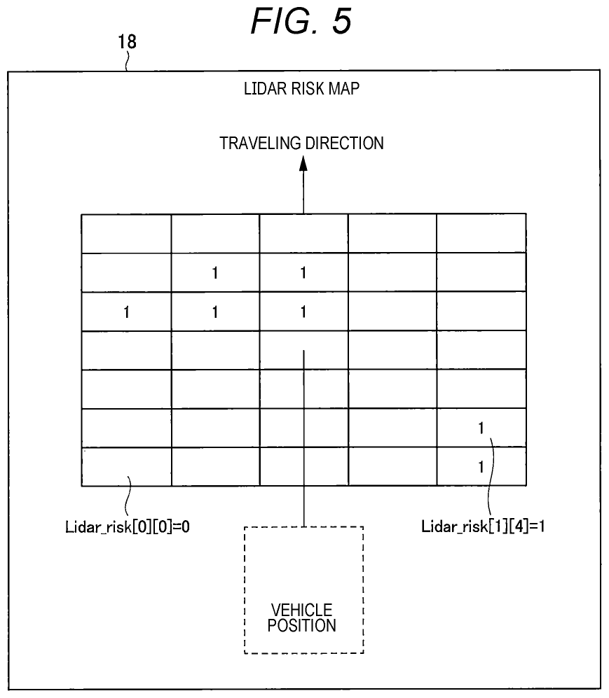

FIG. 5 is a diagram illustrating an example of the LIDAR risk map 18 according to the first embodiment.

The LIDAR risk map 18 is a two-dimensional array that stores integer values, divides the front region (measurement region in the traveling direction) of the vehicle 100 into grids, and substitutes 1 for the grid (array element) in which the presence of an object is detected by the LIDAR object detection data 12 and 0 for the other grids (array elements) (description of 0 is omitted in FIG. 5). For example, since no object is detected in the lower left corner of the grid, 0 is substituted for Lidar_risk[0] [0]. In addition, since an object is detected in a grid moved in the traveling direction by one grid (one grid in the upward direction in the drawing) from the lower right corner of the grid, 1 is substituted for Lidar_risk[1] [4].

The description returns to FIG. 3. In Step S3, the automatic driving ECU 3 superimposes the camera risk map 17 and the LIDAR risk map 18 to generate the risk map 19.

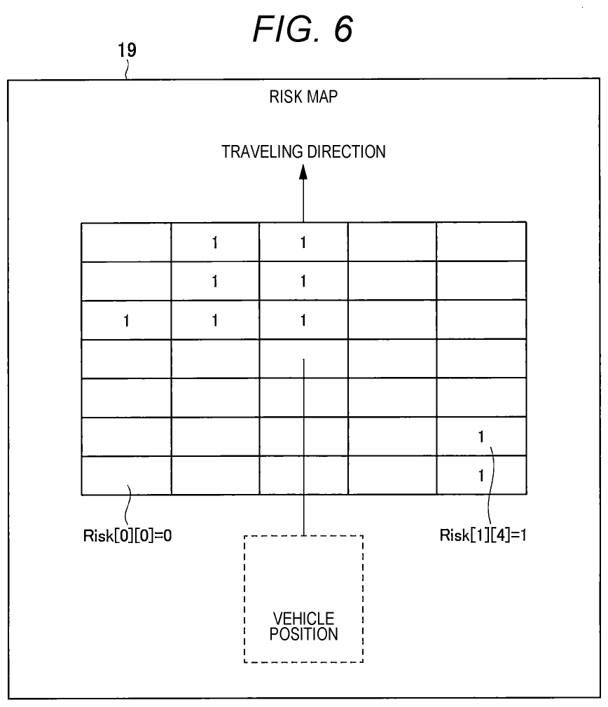

FIG. 6 is a diagram illustrating an example of the risk map 19 (composite risk map) superimposed in the first embodiment.

In the present embodiment, 1 is substituted into a grid (array element) in which an object is detected in at least one of the camera risk map 17 and the LIDAR risk map 18. For example, since an object is detected in the camera risk map 17, 1 is substituted into Risk[6] [1] of the risk map 19. In addition, since an object is detected in the LIDAR risk map 18, 1 is substituted to Risk[0] [4] of the risk map 19. In addition, since no object is detected in both the camera risk map 17 and the LIDAR risk map 18, 0 is substituted for Risk[6] [4] of the risk map 19.

The description returns to FIG. 3. In Step S4, the automatic driving ECU 3 generates the traveling trajectory 20 of the vehicle 100 using the information of the risk map 19. The trajectory generation may be performed by any method and is not related to the present invention, and thus the illustration thereof is omitted. In addition, since the format of the data representing the traveling trajectory 20 is not related to the present invention, the illustration thereof is omitted.

In Step S5, the automatic driving ECU 3 generates a control command value (steering control command 13, accelerator control command 14, and brake control command 15) using the information of the traveling trajectory 20. The command value generation may be performed by an arbitrary method and is not related to the present invention, and thus the illustration thereof is omitted. Further, since the formats of the steering control command 13, the accelerator control command 14, and the brake control command 15 are not related to the present invention, the illustration thereof is omitted.

From the above, noted that the generation of the camera risk map 17 in Step S1 and the generation of the LIDAR risk map 18 in Step S2 are not related to each other. Furthermore, note that the risk map superimposition in Step S3 is related to the camera risk map 17 and the LIDAR risk map 18. That is, in order to start the risk map superimposition processing, both the camera risk map 17 and the LIDAR risk map 18 need to be generated.

### <Control Cycle>

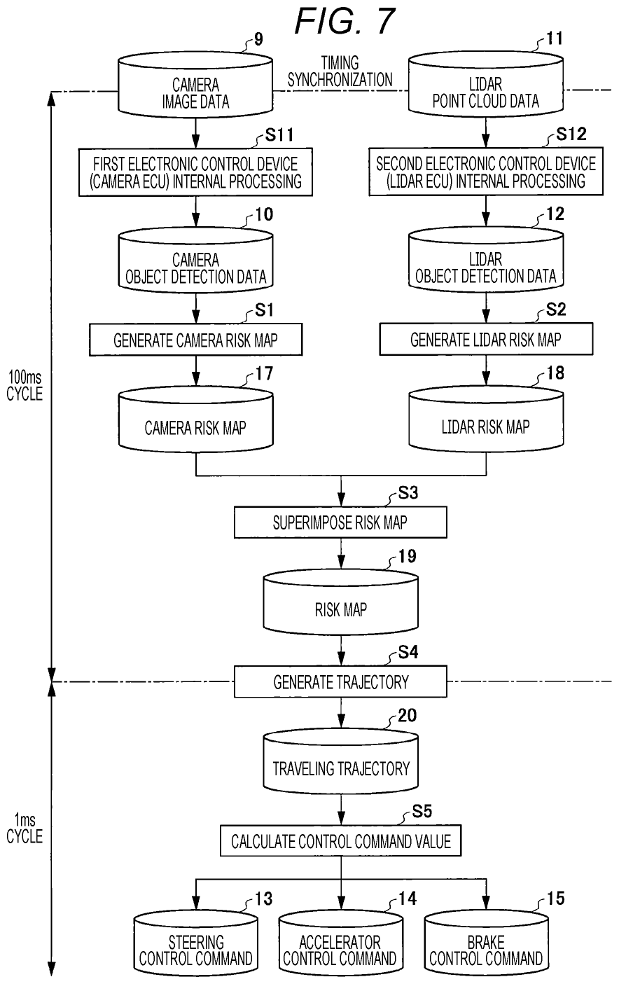

FIG. 7 is a diagram illustrating an example of a control cycle of the electronic system 110 according to the first embodiment.

The electronic system 110 acquires the camera image data 9, and generates the camera object detection data 10 from the camera image data 9 (S11). This processing is executed as internal processing of the camera ECU 1. The electronic system 110 also acquires the LIDAR point cloud data 11 and generates the LIDAR object detection data 12 from the LIDAR point cloud data 11 (S12). This processing is executed as an internal process of the LIDAR ECU 2.

The electronic system 110 synchronously executes acquisition of the camera image data 9 (S11) and acquisition of the LIDAR point cloud data 11 (S11), and executes processing from the data acquisition to generation of the traveling trajectory 20 (S4) every 100 ms. In addition, the electronic system 110 executes generation (S5) of the control command value (steering control command 13, accelerator control command 14, and brake control command 15) based on the traveling trajectory 20 every 1 ms. Note that the cycle is merely an example, and is not limited thereto.

Hereinafter, in the present embodiment, in particular, acquisition of the camera image data 9 and acquisition of the LIDAR point cloud data 11 to generation of the traveling trajectory 20 will be described.

### <Time Required for Communication Between ECUs>

The camera object detection data 10 is generated and transmitted by the camera ECU 1, and the LIDAR object detection data 12 is generated and transmitted by the LIDAR ECU 2. Since the two pieces of object detection data are received by the automatic driving ECU 3, communication occurs between the ECUs. In the present embodiment, the (allowable) time required for communication between the camera ECU 1 and the automatic driving ECU 3 and between the LIDAR ECU 2 and the automatic driving ECU 3 is set to 10 ms. That is, it is guaranteed that the camera image data 9 always arrives at the automatic driving ECU 3 10 ms after the camera image data 9 is transmitted from the camera ECU 1.

This is because the in-vehicle network 16 of the present embodiment employs a communication scheme in which the times of all the ECUs connected to the in-vehicle network 16 are synchronized and data transmission can be guaranteed within a certain period of time. As a result, the LET can be extended between the ECUs.

<Task from Data Acquisition to Trajectory Generation>

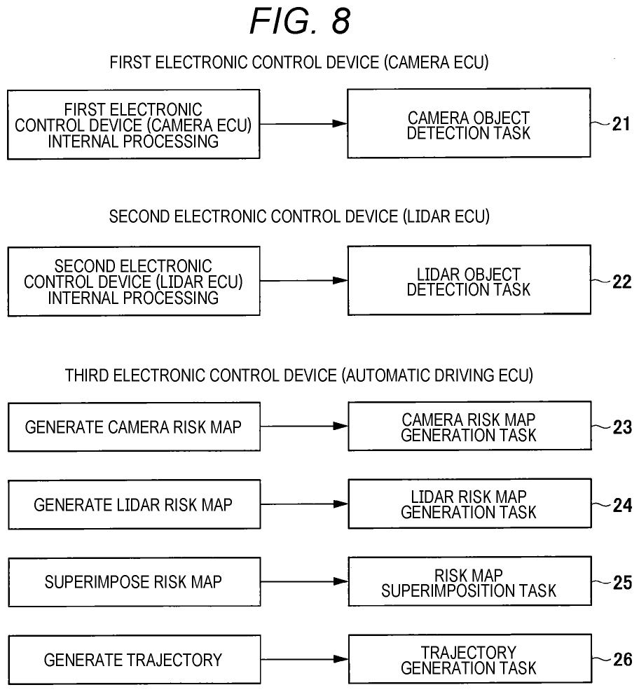

FIG. 8 is a diagram illustrating an example in which processing from data acquisition to trajectory generation in the first embodiment is mapped to a task.

The camera ECU 1 (first electronic control device) acquires the camera image data 9 from the camera 4, performs calculation, and transmits the result as the camera object detection data 10. In the present specification, all the processes are collectively referred to as a “camera object detection task 21” (first task).

The LIDAR ECU 2 (second electronic control device) acquires the LIDAR point cloud data 11 from the LIDAR 5, performs calculation, and transmits the result as the LIDAR object detection data 12. In the present specification, all the processes are collectively referred to as a “LIDAR object detection task 22” (second task).

In the automatic driving ECU 3 (third electronic control device), processing from reception of the camera object detection data 10 to generation of the camera risk map 17 and writing thereof into the global memory 54 of the automatic driving ECU 3 is referred to as a “camera risk map generation task 23”.

Further, in the automatic driving ECU 3, processing from reception of the LIDAR object detection data 12 to generation of the LIDAR risk map 18 and writing thereof into the global memory 54 of the automatic driving ECU 3 is referred to as a “LIDAR risk map generation task 24”.

Further, in the automatic driving ECU 3, processing from reading the camera risk map 17 and the LIDAR risk map 18 from the global memory 54 of the automatic driving ECU 3 to generating the risk map 19 and writing thereof into the global memory 54 of the automatic driving ECU 3 is referred to as a “risk map superimposition task 25”.

Processing from reading the risk map 19 from the global memory 54 of the automatic driving ECU 3 to writing the traveling trajectory 20 into the global memory 54 of the automatic driving ECU 3 is referred to as a “trajectory generation task 26”.

The automatic driving ECU 3 generates a series of tasks (third task) including the camera risk map generation task 23, the LIDAR risk map generation task 24, the risk map superimposition task 25, and the trajectory generation task 26 described above.

That is, the camera object detection task 21 is executed in the camera ECU 1. The LIDAR object detection task 22 is executed in the LIDAR ECU 2. Then, the camera risk map generation task 23, the LIDAR risk map generation task 24, the risk map superimposition task 25, and the trajectory generation task 26 are executed in the automatic driving ECU 3.

### <LET Correspondence of Task>

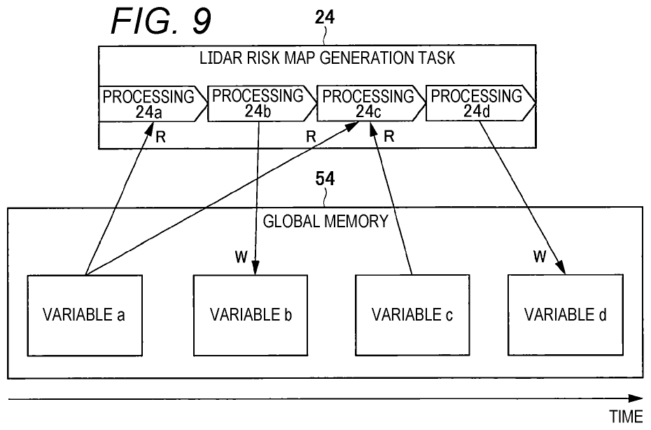

FIG. 9 is a diagram illustrating an example before the task is made to correspond to the LET.

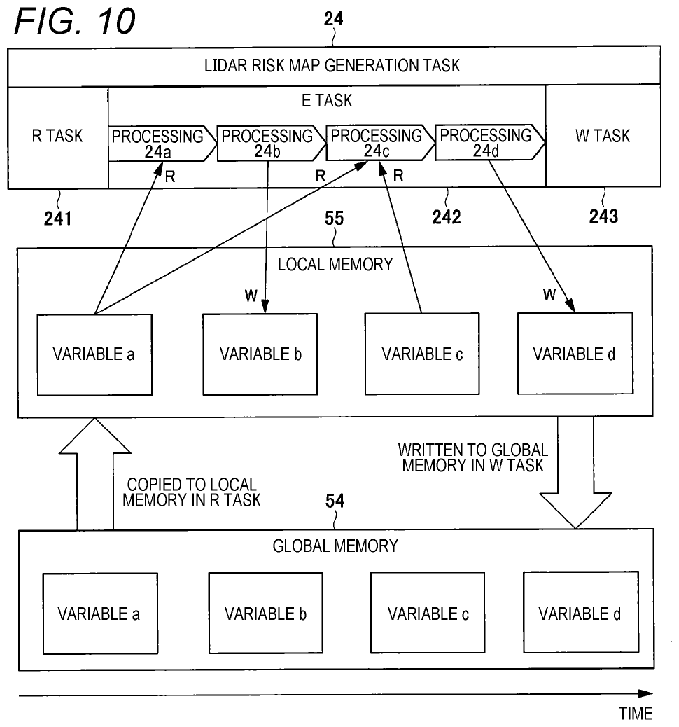

FIG. 10 is a diagram illustrating an example after the task according to the first embodiment of the present invention is made to correspond to LET. In FIGS. 9 and 10, a horizontal axis represents time (flow of time).

The LIDAR risk map generation task 24 will be described as an example. In FIG. 9, the LIDAR risk map generation task 24 includes a plurality of processing 24a to 24d. The LIDAR risk map generation task 24 reads a global variable a in the processing 24a and reads the global variable a and a global variable c in the processing 24c. Then, the LIDAR risk map generation task 24 writes a global variable b in the processing 24b and writes a global variable d in the processing 24d.

As described above, in a case where reading and writing from and to the global variable are performed at an arbitrary timing, when there is a deviation in the execution timing of the LIDAR risk map generation task 24, the value of the global variable to be read and written is different, and the calculation result is non-deterministic. This causes a large number of verification man-hours to be required for changing the task scheduling.

Therefore, the LET is introduced into task scheduling, and the LIDAR risk map generation task 24 is divided into three tasks (LIDAR risk map generation R task 241, LIDAR risk map generation E task 242, LIDAR risk map generation W task 243) illustrated in FIG. 10. First, in the LIDAR risk map generation R task 241, the global variables a to d read and written for LIDAR risk map generation are copied from the global memory 54 to the local memory 55. The global variables a to d copied to the local memory 55 are simply referred to as variables a to d.

Next, in the LIDAR risk map generation E task 242, the processing 24a to 24d is executed. At this time, the LIDAR risk map generation E task 242 does not directly read and write the global variables a to d from and to the global memory 54, but uses the variables a to d copied to the local memory 55 in the LIDAR risk map generation R task 241.

Finally, in the LIDAR risk map generation W task 243, the variables a to d of the local memory 55 are written to the global variables a to d of the global memory 54.

By doing so, as long as the execution timings of the LIDAR risk map generation R task 241 and the LIDAR risk map generation W task 243 are fixed, it is ensured that the calculation result is unchanged even when the execution timing of the LIDAR risk map generation E task 242 varies.

Similarly to the LIDAR risk map generation task 24, each task illustrated in FIG. 8 is divided into an R task, a W task, and an E task. Hereinafter, the method of determining the name (R task, W task, E task) and the number of the task in the present specification is assumed to follow the example of the LIDAR risk map generation task 24.

As described above, each task processing unit (camera ECU 1, LIDAR ECU 2, and automatic driving ECU 3) includes a memory (global memory 54, local memory 55) as a target for reading information necessary for execution of the task and writing the processing result of the task.

### <Normal LET Interval>

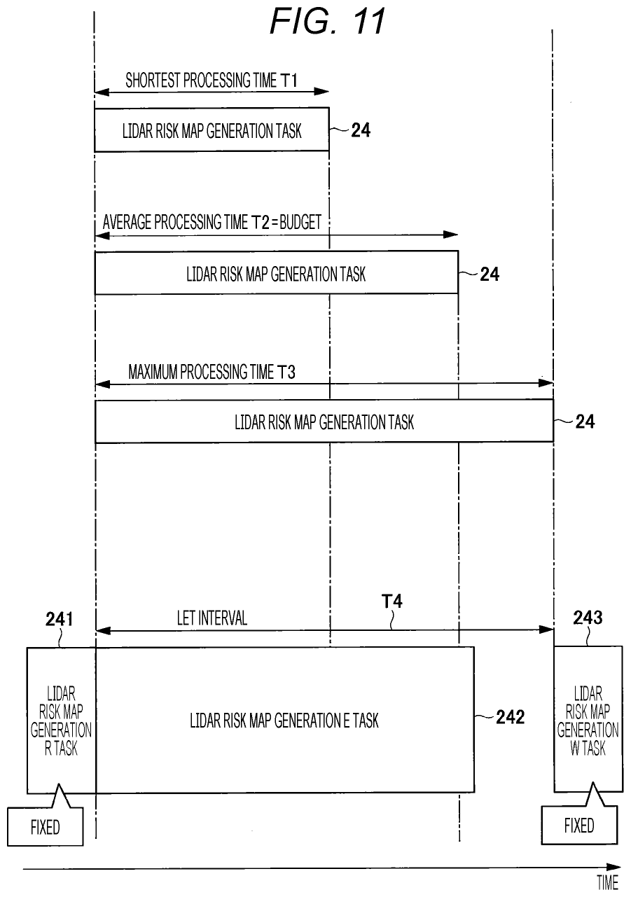

FIG. 11 is a diagram for explaining intervals in a normal LET. In FIG. 11, a horizontal axis represents time.

The processing time required for the LIDAR risk map generation R task 241 and the LIDAR risk map generation W task 243 is sufficiently smaller than the processing time required for the LIDAR risk map generation E task 242. Therefore, the processing time of the LIDAR risk map generation task 24 is substantially equal to the processing time of the LIDAR risk map generation E task 242. In FIG. 11, it is merely described that the processing times of the LIDAR risk map generation R task 241 and the LIDAR risk map generation W task 243 are long due to the relationship of representing characters. Note that FIG. 11 illustrates a case where the processing time of the LIDAR risk map generation task 24 is the shortest processing time T1, the average execution time T2 (corresponding to budget), and the maximum processing time T3 that is the worst execution time.

The processing time for LIDAR risk map generation varies depending on the surrounding environment of the vehicle 100. In the LET, it is important that the read/write timing to the global memory 54 is fixed. Therefore, when the timing of the LIDAR risk map generation R task 241 and the LIDAR risk map generation W task 243 is fixed, it is necessary to ensure that the LIDAR risk map generation E task 242 ends during the fixed timing. For this purpose, the time (LET interval T4) from the end of the LIDAR risk map generation R task 241 to the start of the LIDAR risk map generation W task 243 needs to be equal to or more than the maximum processing time T3 of the LIDAR risk map generation task 24. When this is applied to the tasks in all the ECUs, it is equivalent to considering a condition that all the tasks require the worst execution time at the same time, and the CPU utilization efficiency is significantly reduced.

Since the LIDAR risk map generation R task 241 and the LIDAR risk map generation W task 243 are only reading and writing from and to the global memory 54 and the local memory 55, the processing time required for each task is substantially constant every time.

### <Reference Time (Budget) and Time Margin (Margin)>

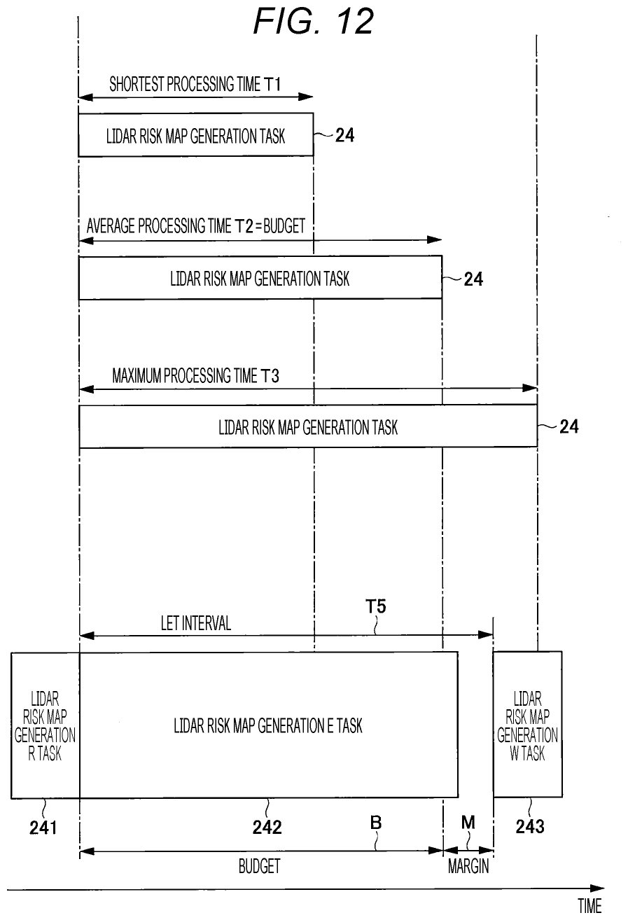

FIG. 12 is a diagram for describing a reference time (budget) and a time margin (margin) according to the first embodiment.

FIG. 12 also illustrates a case where the processing time of the LIDAR risk map generation task 24 is the shortest processing time T1, the average execution time T2 (budget), and the maximum processing time T3 which is the worst execution time.

In the present embodiment, the interval in the LIDAR risk map generation is determined on the basis of the problem of the determination method illustrated in FIG. 11. That is, the interval in the LIDAR risk map generation is determined not by the maximum processing time T3 of the LIDAR risk map generation E task 242, but by the average execution time T2 (average execution time) of the LIDAR risk map generation E task 242. The average execution time T2 is also described as an “average execution time T2”, and is set as a reference time (budget B). Furthermore, an appropriate time margin (margin M) is determined, and a time obtained by adding the budget B and the margin M is set as the LET interval T5 in the generation of the LIDAR risk map. Here, the method of determining the margin M may be, for example, twice the standard deviation of the processing time required for generating the LIDAR risk map.

### <Extension of Interval and Sharing of Margin>

In a case where the budget B is the average execution time T2, when the worst execution time is required for the LIDAR risk map generation, the completion of the LIDAR risk map generation E task 242 will not be in time for the start timing of the LIDAR risk map generation W task 243. Therefore, the margin M is shared among a plurality of tasks, and the execution timing of the LIDAR risk map generation W task 243 is made variable.

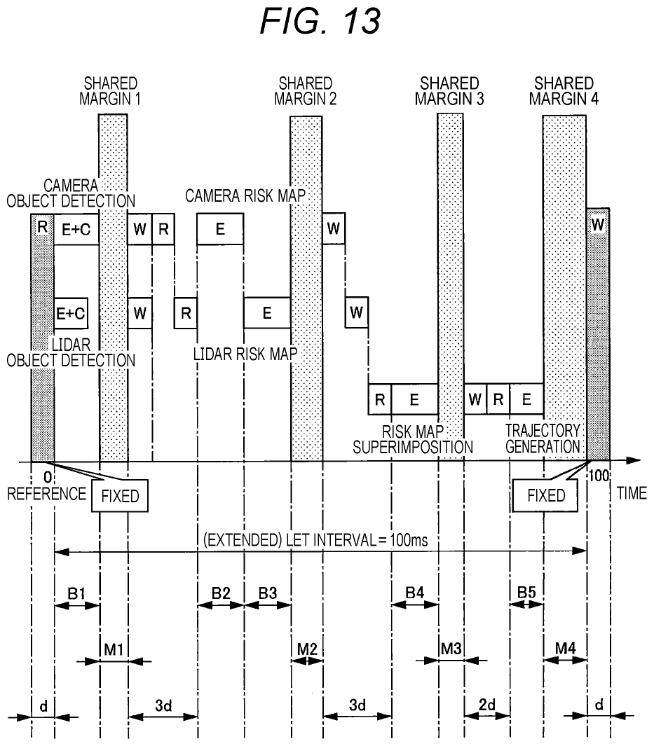

FIG. 13 is an example of a timing chart illustrating the extension of the interval and the sharing of the margin in the first embodiment. In FIG. 13, a horizontal axis represents time (flow of time). FIG. 13 illustrates execution timings of the camera object detection task 21, the LIDAR object detection task 22, the camera risk map generation task 23, the LIDAR risk map generation task 24, the risk map superimposition task 25, and the trajectory generation task 26. In the drawing, reference numerals representing the tasks are omitted.

In the present embodiment, as illustrated in FIG. 7, the electronic system 110 synchronously executes acquisition of the camera image data 9 and acquisition of the LIDAR point cloud data 11, and executes from the data acquisition to generation of the traveling trajectory 20 at a cycle of 100 ms. For this reason, the camera object detection R task and the LIDAR object detection R task synchronized with the camera object detection R task are fixed, the trajectory generation W task is further fixed, and the remaining tasks are variable and share a margin among the tasks. That is, the LET interval is (extended) from the start of the camera object detection E task and the LIDAR object detection E task to the end of the trajectory generation E task, and its value is 100 ms.

As described above, the (extended) LET interval (predetermined time interval) is a limit time from the timing of reading information necessary for execution of the first or second task (for example, camera object detection task 21 or LIDAR object detection task 22) from the first or second memory (for example, the global memory 54) to the timing of writing the processing result of the third task (for example, trajectory generation task 26) to the third memory (for example, the global memory 54). This limit time is fixed in advance.

The budget of each task conforms to the average execution time T2 of the E task. However, in a case where communication (transmission) is included, a required communication time d is added, and in a case where there are tasks to be processed by different ECUs in parallel, a task having the longest average execution time T2 among the tasks is set as the budget.

For example, a value (E+C) obtained by adding the required communication time of 10 ms (C) to the average execution time T2 (E) of the camera object detection E task is the budget B1 for camera object detection. For the LIDAR object detection (LIDAR ECU 2) performed in parallel with the camera object detection (camera ECU 1), the value obtained by adding the time required for communication 10 ms to the average execution time T2 of the LIDAR object detection E task is smaller than B1, and thus does not affect the calculation of the budget B1.

When the value obtained by adding the communication required time of 10 ms to the average execution time T2 of the LIDAR object detection E task is larger than the value obtained by adding the communication required time of 10 ms to the average execution time T2 of the camera object detection E task, the value obtained by adding the communication required time of 10 ms to the average execution time T2 of the LIDAR object detection E task is the budget B1.

In FIG. 13, a time obtained by adding a period (shared margins 1 to 4) in which processing is not described becomes a margin and is shared among the E tasks included in the (extended) LET interval. That is, when the lengths of the shared margins 1 to 4 are M1 to M4, the shared margin is M1+M2+M3+M4. The shared margins 1 to 4 are used in the processing of the task in a case where an execution delay occurs in any of the first task (camera object detection task 21), the second task (LIDAR object detection task 22), and the third task (for example, the camera risk map generation task 23 to the activation generation task 26). Then, assuming that the processing time of each R task and each W task is constant at d, the following equation is established from the timing chart of FIG. 13. 2d or 3d represents twice or three times the processing time d.

M1+M2+M3+M4=100−(B1+B2+B3+B4+B5)−(d+3d+3d+2d+d)

As a result, it is guaranteed that the generation of the traveling trajectory 20 is executed at a cycle of 100 ms as long as a plurality of E tasks included in the (extended) LET interval do not simultaneously cause a processing delay.

In the case of the normal LET, for example, the start timing of the camera object detection W task is fixed.

Therefore, in a case where (camera object detection E task+time required for communication 10 ms) becomes larger than B1+M1, a deadline error occurs immediately, and LET scheduling fails. However, as in the present embodiment, by sharing the LET interval and the margin, when all the other tasks fall within the budget, even though (camera object detection E task+communication required time 10 ms) is delayed to B1+M1+M2+M3+M4, the deadline can be observed.

As illustrated in FIG. 13, in the automatic driving ECU 3 of the present embodiment, normally, the camera risk map generation is scheduled to be executed before the LIDAR risk map generation.

### <Timing Chart Change for Task Processing Order Change>

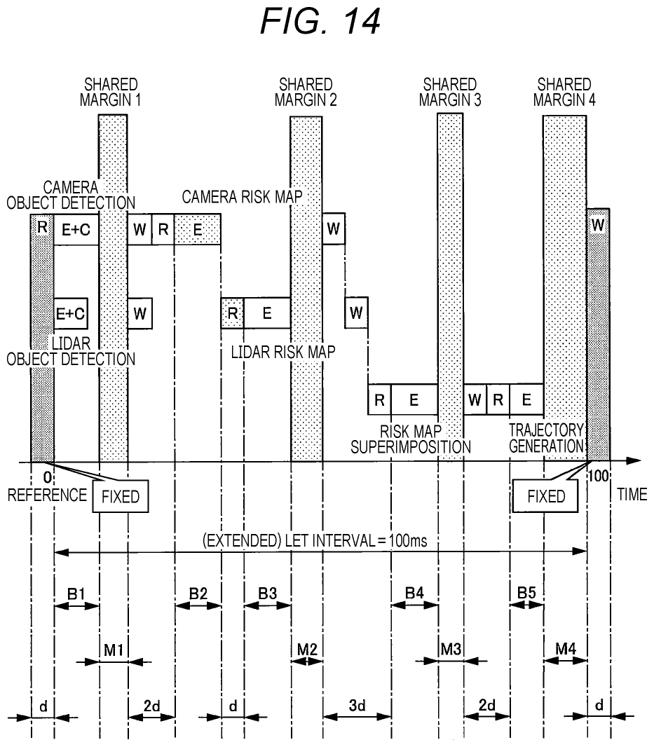

FIG. 14 is an example of an improved timing chart in view of the processing order change in the first embodiment.

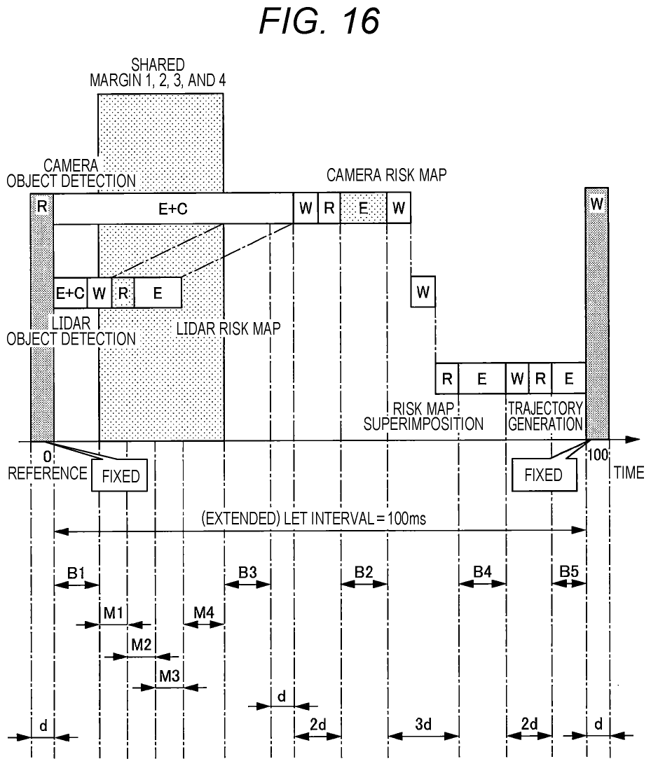

In FIG. 13, execution timings of tasks other than the camera object detection R task (and the LIDAR object detection R task) and the trajectory generation W task are variable. Therefore, as illustrated in FIG. 14, the execution order of the camera risk map generation E task and the LIDAR risk map R task is changed. This is necessary to make it possible to change the execution order of the camera risk map generation and the LIDAR risk map generation in FIG. 16 to be described later. Note that the execution order of the tasks is synonymous with the activation order of the tasks.

<Maximum Processing Delay Allowable Time when Processing Order is not Changed>

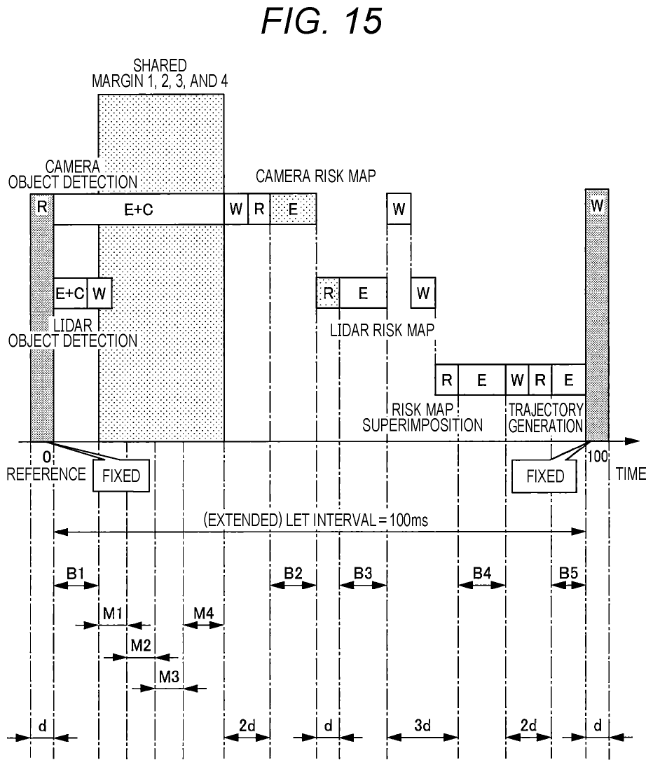

FIG. 15 is an example of a timing chart illustrating a processing delay allowed to the maximum in a case where the processing order is not changed in the first embodiment.

In order to comply with the tasks included in the (extended) LET interval, the maximum processing time allowed for the camera risk map generation E task is B1+M1+M2+M3+M4−10 ms (time required for communication). When more processing time is required, the trajectory generation W task cannot meet the control cycle of 100 ms.

<Maximum Processing Delay Allowable Time when Processing Order is Changed>

FIG. 16 is an example of a timing chart illustrating a processing delay allowed to the maximum in a case where the processing order is changed in the first embodiment.

As described above, in the series of task processing, the generation of the camera risk map 17 and the generation of the LIDAR risk map 18 are not related to each other. Furthermore, in the series of task processing, the risk map superimposition is related to the camera risk map 17 and the LIDAR risk map 18. That is, in order to start the risk map superimposition processing, both the camera risk map 17 and the LIDAR risk map 18 need to be generated.

From these, when the camera object detection E task is delayed, the electronic system 110 executes the LIDAR risk map generation E task first, and then executes the camera risk map generation E task after the end of the camera object detection E task and the W task. Finally, a camera risk map generation W task and a LIDAR risk map generation W task are executed.

Therefore, to comply with the tasks included in the (extended) LET interval, the maximum processing time allowed for the camera risk map generation E task is B1+M1+M2+M3+M4+d+B3−10 ms (time required for communication). When more processing time is required, the trajectory generation W task cannot meet the control cycle of 100 ms.

As described above, by changing the task processing order, the delay of the camera object detection E task is further allowed as compared with the case where the change is not performed. This corresponds to the sum (d+B3) of the global variable reading time in the task processing in which the order is just changed and the budget assigned to the task processing.

### <Recalculation of Scheduling>

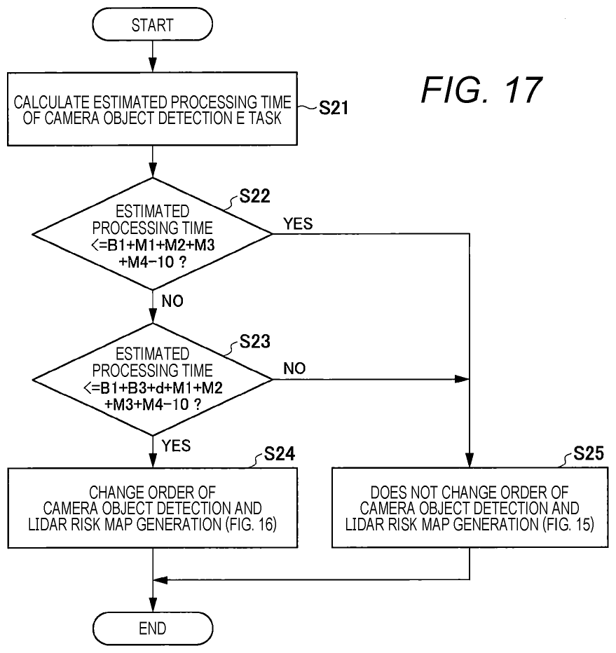

Here, a concept of recalculation of scheduling will be described with reference to FIG. 17.

FIG. 17 is a flowchart for determining whether it is necessary to perform the change of the processing order in the third electronic control device (automatic driving ECU 3) according to the first embodiment. As illustrated in FIGS. 13 to 16, a case where the automatic driving ECU 3 executes the camera risk map generation task 23, the LIDAR risk map generation task 24, the risk map superimposition task 25, and the trajectory generation task 26 will be assumed in FIG. 17.

First, in the automatic driving ECU 3, a scheduling recalculation unit 82 calculates an estimated processing time of the camera object detection E task executed by the camera ECU 1 (S21). The estimated processing time is a time at which the processing of the target task is estimated to end. For example, from FIG. 15, the estimated processing time of the camera object detection E task is “B1”.

Next, the scheduling recalculation unit 82 determines whether the estimated processing time of the camera object detection E task is equal to or less than time “B1+M1+M2+M3+M4−10” [ms] (S22). Here, when the estimated processing time is equal to or less than “B1+M1+M2+M3+M4−10” [ms] (YES in S22), the scheduling recalculation unit 82 advances the processing to Step S25. Moreover, when the estimated processing time exceeds “B1+M1+M2+M3+M4−10” [ms] (NO in S22), the scheduling recalculation unit 82 advances the processing to the determination processing in Step S23.

Next, in Step S23, the scheduling recalculation unit 82 determines whether the estimated processing time of the camera object detection E task is equal to or less than “B1+B3+d+M1+M2+M3+M4−10” [ms] (S23). In this determination processing, the budget B3 and the required communication time d of the LIDAR risk map generation E task are included in the margin. Then, in a case where the estimated processing time exceeds “B1+B3+d+M1+M2+M3+M4−10” [ms] (NO in S23), the scheduling recalculation unit 82 advances the processing to Step S25. In addition, in a case where the estimated processing time is equal to or less than “B1+B3+d+M1+M2+M3+M4−10” [ms] (YES in S23), the scheduling recalculation unit 82 advances the processing to Step S24.

Next, in the case of YES determination in Step S23, the scheduling recalculation unit 82 changes the order of the camera object detection and the LIDAR risk map generation (see FIG. 16) (S24).

Meanwhile, when the determination is YES in Step S22 or NO in Step S23, the scheduling recalculation unit 82 does not change the order of the camera object detection and the LIDAR risk map generation (see FIG. 15) (S25). After the processing of Step S24 or S25, the processing of this flowchart ends.

As described above, in the present embodiment, the automatic driving ECU 3 determines the change of the execution order based on whether the estimated processing time of the camera object detection E task exceeds the maximum allowable processing time when the execution order is not changed and is within the maximum allowable processing time when the execution order is changed (S23).

Only when the estimated processing time exceeds the maximum allowable processing time in a case where the execution order is not changed and is within the maximum allowable processing time in a case where the execution order is changed (YES in S23), the automatic driving ECU 3 changes the execution order of the camera risk map generation R/E task and the LIDAR risk map generation R/E task as illustrated in FIG. 16 (S24).

On the other hand, when this condition is not satisfied (YES in S22 or NO in S23), the execution order of each task is set as illustrated in FIG. 15 (no change in task scheduling) (S25).

The determination processing in Steps S22 and S23 may be performed based on an estimated excess time [ms] included in processing time excess task information Ie to be described later.

### <Configuration of Scheduling Function>

Next, a configuration for implementing the scheduling function illustrated in FIGS. 15 to 17 will be described.

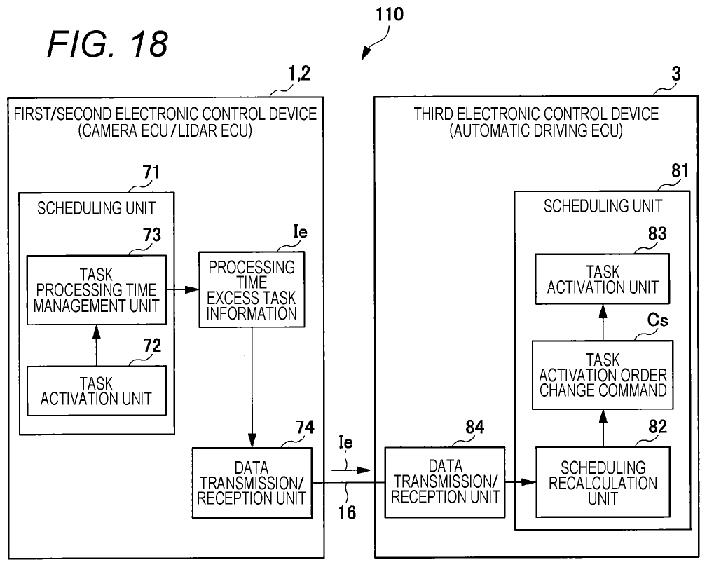

FIG. 18 is a block diagram illustrating a scheduling function of each electronic control device (ECU) according to the first embodiment. These functions are implemented by the CPU 51 (see FIG. 2) included in each ECU executing a program stored in the ROM 52 or the like.

As illustrated, the first electronic control device (camera ECU 1) and the second electronic control device (LIDAR ECU 2) include a scheduling unit 71 and a data transmission/reception unit 74.

The scheduling unit 71 executes a task on the basis of a processing schedule (activation order) of the task. The scheduling unit 71 includes a task activation unit 72 and a task processing time management unit 73. At least the camera ECU 1 includes a task processing time management unit 73.

The task activation unit 72 activates and executes tasks assigned to the ECUs in a set activation order.

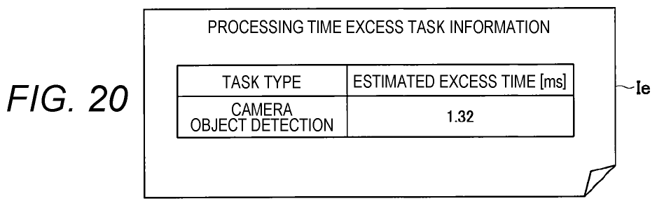

The task processing time management unit 73 (an example of a processing time management unit) manages the processing time of the activated task. When the time required for processing the activated task exceeds a predetermined time, the task processing time management unit 73 generates the processing time excess task information Ie (see FIG. 20 to be described later) including information related to the time when the processing of the task is estimated to end, and transmits the processing time excess task information Ie to the data transmission/reception unit 74 using the in-vehicle network 16.

The data transmission/reception unit 74 transmits and receives data to and from the automatic driving ECU 3 via the in-vehicle network 16. Here, the data transmission/reception unit 74 transmits the processing time excess task information Ie to the automatic driving ECU 3. The data transmission/reception unit 74 is realized by the network interface 57.

Note that the task processing time management unit 73 of the scheduling unit 71 may be provided only in the camera ECU 1 that executes the camera object detection task 21 that requires a longer processing time.

The third electronic control device (automatic driving ECU 3) includes a scheduling unit 81 and a data transmission/reception unit 84.

The scheduling unit 81 executes a task on the basis of a processing schedule (activation order) of the task. The scheduling unit 81 includes a scheduling recalculation unit 82 and a task activation unit 83.

The scheduling recalculation unit 82 recalculates the processing schedule of the automatic driving ECU 3 based on the processing time excess task information Ie received from the camera ECU 1 or the LIDAR ECU 2. Then, in a case where it is necessary to change the task activation order by recalculation, the scheduling unit 81 generates a task activation order change command Cs and outputs the command Cs to the task activation unit 83.

The task activation unit 83 activates and executes tasks assigned to the ECUs in a set activation order. When receiving the task activation order change command Cs from the scheduling recalculation unit 82, the task activation unit 83 changes the task activation order based on the task activation order change command Cs to activate the task.

The data transmission/reception unit 84 transmits and receives data to and from the camera ECU 1 and the LIDAR ECU 2 via the in-vehicle network 16. Here, the data transmission/reception unit 84 receives the processing time excess task information Ie from the camera ECU 1 and the LIDAR ECU 2. The data transmission/reception unit 84 is realized by the network interface 57.

### <Processing Time Management of Camera Object Detection E Task (Calculation of Estimated Processing Time)>

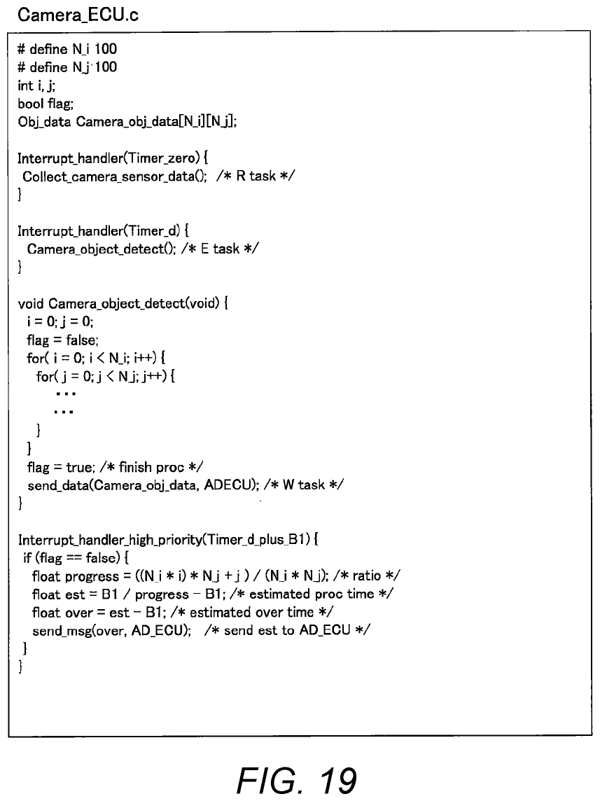

Next, calculation of the estimated processing time will be described with reference to FIG. 19.

FIG. 19 is a diagram illustrating an example of a method of calculating the estimated processing time of the camera object detection E task in the first electronic control device (camera ECU 1) according to the first embodiment. In FIG. 19, the method of calculating the estimated processing time is represented by a source code.

In order to detect a camera object, it is necessary to scan the camera image line by line, perform double loop processing using a for sentence until scanning of all pixels is completed, and perform a total of N_i*N_j operations. Therefore, in the camera ECU 1, a timer interruption is generated at a time “d+B1” at which the camera object detection data 10 is transmitted (is to be transmitted) from the camera ECU 1 to the automatic driving ECU 3. Then, in a case where the camera object detection E task is not completed at the time “d+B1”, the task processing time management unit 73 calculates the progress on the basis of the value of the double loop index (scanning position expressed by suffixes i and j). The progress can be obtained by a ratio between the total number of pixels of the camera image and the number of pixels for which the calculation ends. That is, a progress rate progress can be calculated by ((N_i*i)*N_j+j)/(N_i*N_j).

Because the progress rate is progress when the processing time is B1, the estimated processing time est at which the double loop processing ends can be calculated as B1/progress. Therefore, the estimated excess time over of the processing for the budget B1 is calculated as est−B1. Finally, the camera ECU 1 transmits the value of the estimated excess time over calculated by the task processing time management unit 73 to the automatic driving ECU 3 as the processing time excess task information Ie (the transmission processing is the camera object detection W task.).

As described above, the time (estimated processing time) when the task processing is estimated to end is calculated based on the progress rate of the task processing when the reference time of the task processing (for example, a camera object detection task) is exceeded. For example, the progress rate is obtained by dividing a value at the time of exceeding the reference time of the index used in the repetitive processing included in the task processing by the required number of repetitions (for example, the number of pixels corresponds to the number of pixels of the camera image).

### <Processing Time Excess Task Information>

Next, the processing time excess task information Ie will be described with reference to FIG. 20.

FIG. 20 is a diagram illustrating an example of the processing time excess task information Ie transmitted from the first electronic control device (camera ECU 1) to the third electronic control device (automatic driving ECU 3) in the first embodiment.

The processing time excess task information Ie includes items of a “task type” indicating a type of a task having exceeded the processing time and an “estimated excess time” (a value of over calculated above). FIG. 20 illustrates an example in which the task type is “camera object detection” and the estimated excess time [ms] is “1.32”. Note that the type of the task may be described in a format that can be identified between the camera ECU 1 and the automatic driving ECU 3. For example, an identification ID may be assigned to the task in advance. The processing time excess task information Ie transmitted from the LIDAR ECU 2 to the automatic driving ECU 3 is similar to that in FIG. 20.

Next, activation of a task in each electronic control device will be described.

### <Activation of Task in First Electronic Control Device (Camera ECU)>

In the camera ECU 1, the camera object detection R task is set to be executed at a fixed cycle of 100 ms using a timer (not illustrated) mounted on the camera ECU 1.

In addition, the camera object detection E task is set to be activated after d [ms] from the activation of the camera object detection R task using the timer.

Further, processing time management task “Interrupt_handler_high_priority(Timer_d_plus_B1)” illustrated in FIG. 19 is started after B1 [ms] from the activation of the camera object detection E task using the timer. The priority of the timer interruption of the processing time management task is set higher than the priority of the timer interruption of the camera object detection E task so that the processing time management task is activated even during the execution of the camera object detection E task.

Finally, when the camera object detection E task ends, the processing result (camera object detection data 10) of the camera object detection E task is transmitted to the automatic driving ECU 3 (this is the camera object detection W task).

### <Activation of Task in Second Electronic Control Device (LIDAR ECU)>

The activation of the task in the LIDAR ECU 2 is similar to that of the first electronic control device (camera ECU 1). Note that the execution timing of the LIDAR object detection R task is set to be synchronized with the execution timing of the camera object detection R task in the camera ECU 1.

### <Activation of Task in Third Electronic Control Device (Automatic Driving ECU)>

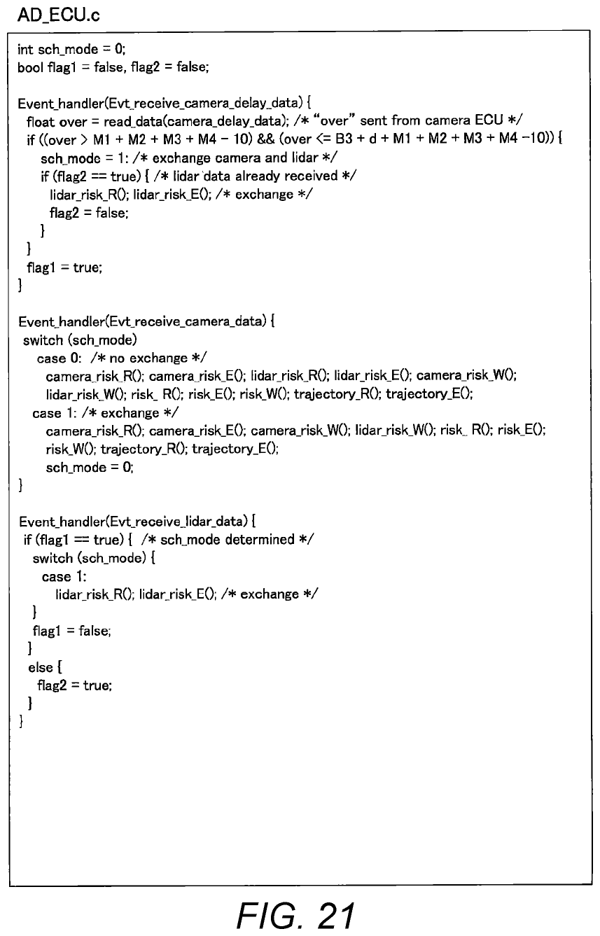

FIG. 21 is a diagram illustrating, by a source code, a method of activating a task in the third electronic control device (automatic driving ECU 3) according to the first embodiment.

As illustrated in FIG. 17 (recalculation of scheduling), only in a case where the estimated excess processing time value of the camera object detection E task exceeds “M1+M2+M3+M4−10” [ms] and is equal to or less than “B3+d+M1+M2+M3+M4−10” [ms], the execution order of the camera risk map generation R/E task and the LIDAR risk map generation R/E task is changed as illustrated in FIG. 16. In addition, in a case where this condition is not satisfied, the execution order of the tasks is as illustrated in FIG. 15 (no change in task scheduling).

Therefore, when receiving the processing time excess task information Ie, the automatic driving ECU 3 acquires the estimated excess time included in the processing time excess task information Ie upon receiving the reception event notification, and sets the value of a variable sch_mode representing the scheduling mode to 1 only when the estimated excess time exceeds “M1+M2+M3+M4−10” [ms] and is equal to or less than “B3+d+M1+M2+M3+M4−10” [ms].

Thereafter, upon receiving the camera object detection data 10 from the camera ECU 1, the automatic driving ECU 3 receives the reception event notification of the data, and when the value of the variable sch_mode is 0 (default value), the automatic driving ECU 3 sequentially performs the camera risk map generation, the LIDAR risk map generation, the risk map superimposition, and the trajectory generation according to FIG. 15. Meanwhile, when the value of the variable sch_mode is 1, since the LIDAR risk map generation has already been previously executed when the camera object detection data 10 is received, the automatic driving ECU 3 sequentially performs the camera risk map generation, the risk map superimposition, and the trajectory generation, which are the remaining processing.

Upon receiving the LIDAR object detection data 12 from the LIDAR ECU 2, the automatic driving ECU 3 receives the reception event notification of the data, and does nothing when the value of the variable sch_mode is 0 (default value). When the value of the variable sch_mode is 1, the LIDAR risk map generation is executed.

In this case, both the reception of the LIDAR object detection data 12 and the arrival timing of the processing time excess task information Ie may arrive at the time “d+B1+10” [ms] when the start of the (extended) LET interval is set to the time 0, particularly when the processing time of the LIDAR object detection ends at B1. Therefore, the automatic driving ECU 3 uses a flag to perform management such that either arrives first.

That is, when the processing time excess task information Ie arrives earlier, the flag 1 is set, and the LIDAR risk map generation is performed at the time of notification of the reception event of the LIDAR object detection data 12. Meanwhile, when the LIDAR object detection data 12 arrives earlier, the flag 0 is set, and the LIDAR risk map generation is performed when the reception event of the processing time excess task information Ie is notified.

As a result, the processing illustrated in FIGS. 15 to 17 is realized.

As described above, in the electronic system according to the first embodiment, the plurality of task processing units (camera ECU 1, LIDAR ECU 2, and automatic driving ECU 3) that processes the assigned tasks are connected via the network (in-vehicle network 16).

Each of the plurality of task processing units includes the task activation unit (task activation unit 72) that activates and executes the task, and the third task processing in the third task processing unit (automatic driving ECU 3) uses at least the processing result of the first task in the first task processing unit (camera ECU 1) or the processing result of the second task in the second task processing unit (LIDAR ECU 2) preceding the third task processing, and periodically executes a series of processing from the preceding first task processing or the second task processing to the third task processing at predetermined time intervals (LET intervals).

In the electronic system according to the present embodiment, the third task (task processing by the automatic driving ECU 3) includes the task that uses the processing result (the camera object detection data 10) of the first task and the task that uses only the processing result (the LIDAR object detection data 12) of the second task without using the processing result of the first task. Then, when the first task processing exceeds the predetermined reference time among the tasks allocated to the third task processing, the third task activation unit (task activation unit 83) activates a task that uses only the processing result of the second task without using the processing result of the first task in advance based on the task activation order change command Cs of the scheduling recalculation unit (scheduling recalculation unit 82).

More specifically, in the electronic system according to the present embodiment described above, when the first task processing ends within the predetermined reference time with respect to the first task processing, the third task activation unit (task activation unit 83) first activates the task (camera risk map generation task) that uses the processing result (camera object detection data 10) of the first task and then activates the task (LIDAR risk map generation task) that uses the processing result (LIDAR object detection data 12) of the second task. Further, when the first task processing exceeds the reference time and the time estimated to end the first task processing included in the processing time excess task information le is the value equal to or less than the sum of the reference time, the used time margin, and the predetermined reference time for the second task processing, the third task activation unit (task activation unit 83) first activates the task (LIDAR risk map generation task) that uses only the processing result (LIDAR object detection data 12) of the second task and then activates the task (camera risk map generation task) that uses the processing result (camera object detection data 10) of the first task.

The processing result of the first task and the processing result of the second task are the processing results of data obtained from the sensing device (camera 4, LIDAR5), and the third task processing unit (automatic driving ECU 3) controls (generate traveling trajectory and calculate control command value) driving of the vehicle using the processing result of the first task and/or the processing result of the second task.

The electronic system according to the first embodiment described above changes the task processing order in the third electronic control device (automatic driving ECU 3) that executes subsequent processing in accordance with the state of load in the first electronic control device (camera ECU 1) that executes preceding processing. As a result, in the present embodiment, it is possible to improve the utilization efficiency of the CPUs mounted on the first and third electronic control devices. In addition, by complying with the (extended) LET interval, there is an effect that it is theoretically ensured that the change in the task scheduling does not affect other processing.

### Second Embodiment

An electronic system and an electronic control device according to a second embodiment of the present invention will be described.

The second embodiment is different from the first embodiment in that, in a case where a processing delay in an electronic control device (first electronic control device) that executes preceding processing is large and processing in a set control cycle cannot be performed in time, subsequent processing in another electronic control device (third electronic control device) is substituted with a previous value. Configurations of the vehicle and the electronic system in the second embodiment are the same as those of the vehicle 100 and the electronic system 110 in the first embodiment. In the second embodiment, the same components as those of the first embodiment are denoted by the same reference numerals, and the description thereof will be omitted.

### <Recalculation of Scheduling>

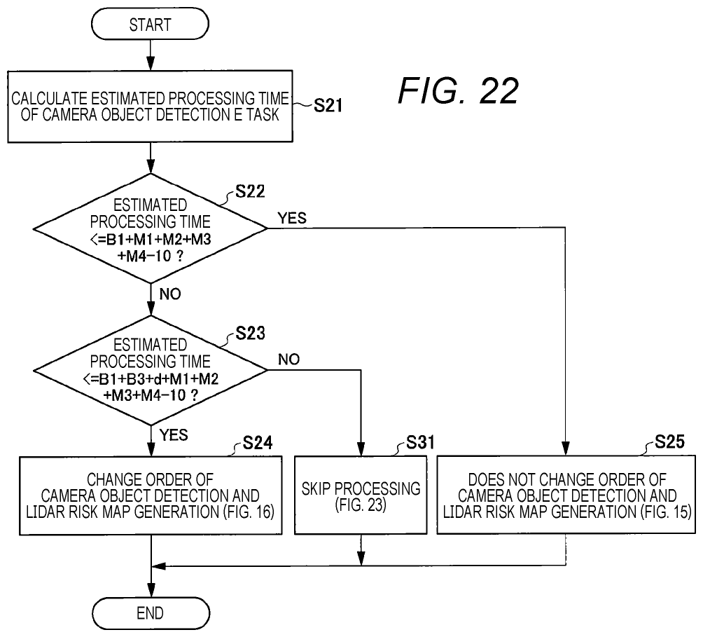

FIG. 22 is a flowchart for determining whether it is necessary to perform the change of the processing order in the second embodiment of the present invention. In FIG. 22, the processing of Step S31 is added as compared with FIG. 17.

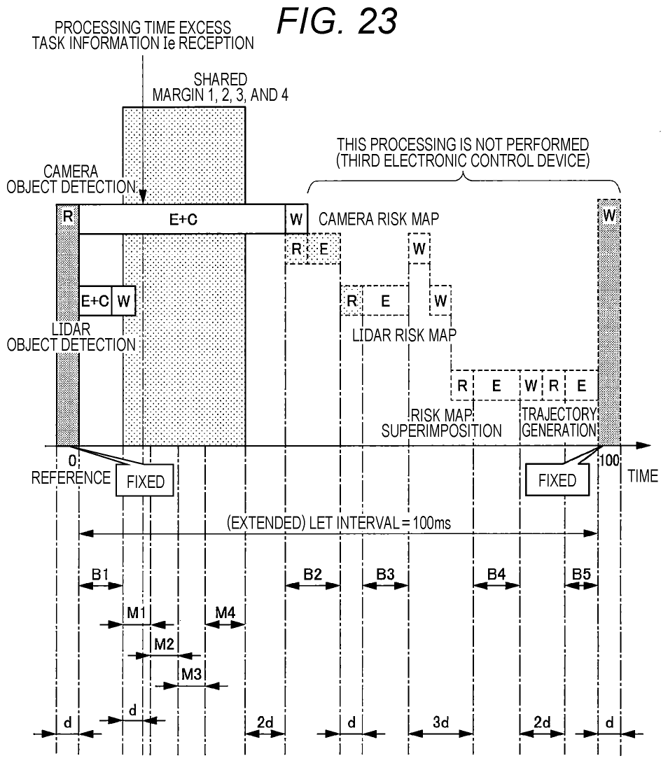

FIG. 23 is a diagram illustrating a timing at which processing is performed by each electronic control device in a case where the processing is skipped in the second embodiment. In FIGS. 22 and 23, portions different from those of the first embodiment will be mainly described.

In FIG. 22, in a case where the estimated processing time of the camera object detection E task exceeds “B1+B3+d+M1+M2+M3+M4−10” [ms] (NO in S23), the scheduling recalculation unit 82 changes the task scheduling so as to skip the subsequent processing (see FIG. 23) (S31). In this case, since it is desired to generate the latest risk map 19, the automatic driving ECU 3 generates the traveling trajectory 20 using the previous risk map 19 and outputs the values of the various control commands 13 to 15.

In the present embodiment, only when YES is determined in Step S22, the scheduling recalculation unit 82 performs the processing of Step S25. That is, the scheduling recalculation unit 82 does not change the order of the camera object detection and the LIDAR risk map generation (see FIG. 15).

After the processing of Steps S24, S25, or S31, the processing of this flowchart is ended.

As described above, in the present embodiment, as in the first embodiment, it is determined whether the execution order is changed based on whether the estimated processing time exceeds the maximum allowable processing time in a case where the execution order is not changed and is within the maximum allowable processing time in a case where the execution order is changed (S23).

Only when the estimated processing time exceeds the maximum allowable processing time in a case where the execution order is not changed and is within the maximum allowable processing time in a case where the execution order is changed (YES in S23), the execution orders of the camera risk map generation R/E task and the LIDAR risk map generation R/E task are changed as illustrated in FIG. 16 (S24).

However, when the estimated processing time exceeds the maximum allowable processing time in a case where the execution order is changed (NO in S23), the processing of the camera risk map generation, the LIDAR risk map generation, the risk map superimposition, and the trajectory generation is skipped and not executed (S31).

Only when the estimated processing time is equal to or less than the maximum allowable processing time when the execution order is not changed (YES in S22), the execution order of each task is set as illustrated in FIG. 15 (no change in task scheduling) (S25).

### <Activation of Task in Third Electronic Control Device (Automatic Driving ECU)>

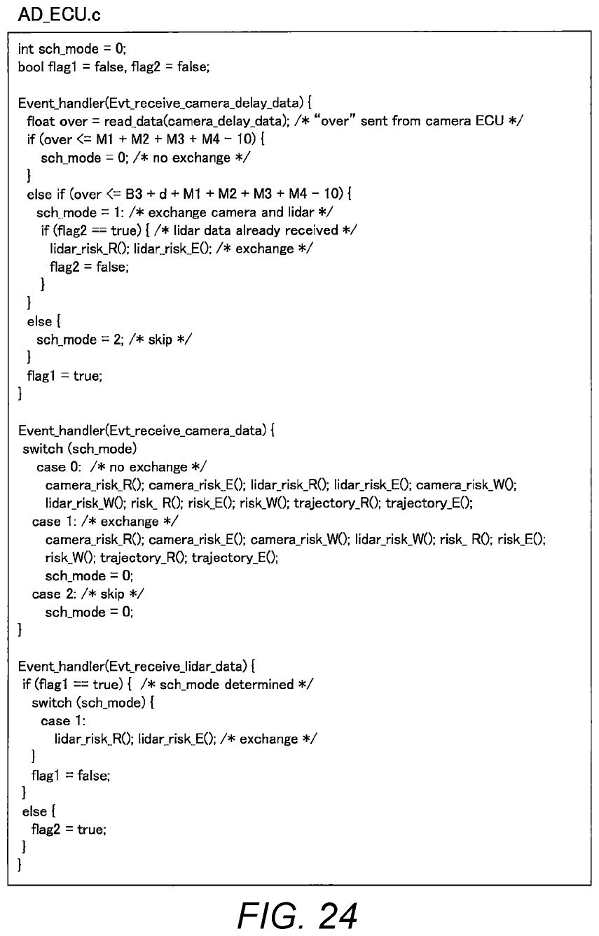

FIG. 24 is a diagram illustrating, by a source code, a method of activating a task in the third electronic control device (automatic driving ECU 3) according to the second embodiment.

When receiving the processing time excess task information Ie, the automatic driving ECU 3 receives the reception event notification and acquires the estimated excess time included in the processing time excess task information Ie, and sets the value of the variable sch_mode representing the scheduling mode to 1 when the estimated excess time exceeds “M1+M2+M3+M4−10” [ms] and is equal to or less than “B3+d+M1+M2+M3+M4−10” [ms]. Here, when the value of the estimated excess time exceeds “B3+d+M1+M2+M3+M4−10” [ms], the value of the variable sch_mode representing the scheduling mode is set to 2.

Thereafter, upon receiving the camera object detection data 10 from the camera ECU 1, the automatic driving ECU 3 receives the reception event notification of the data, and when the value of the variable sch_mode is 0 (default value), the automatic driving ECU 3 sequentially performs the camera risk map generation, the LIDAR risk map generation, the risk map superimposition, and the trajectory generation according to FIG. 15. Meanwhile, in a case where the value of the variable sch_mode is 1, since the LIDAR risk map generation has already been previously executed when the camera object detection data 10 is received, the automatic driving ECU 3 sequentially performs the camera risk map generation, the risk map superimposition, and the trajectory generation which are the remaining processes. Further, when the value of the variable sch_mode is 2, the automatic driving ECU 3 does nothing.

Upon receiving the LIDAR object detection data 12 from the LIDAR ECU 2, the automatic driving ECU 3 receives the reception event notification of the data, and does nothing when the value of the variable sch_mode is 0 (default value) or 2. When the value of the variable sch_mode is 1, the LIDAR risk map generation is executed.

As described above, in the electronic system according to the second embodiment, based on the task activation order change command Cs, when the limit time is still exceeded even when the task (for example, the LIDAR risk map generation task) allocated to the third task processing is executed by the third task activation unit (task activation unit 83), the third task processing unit (automatic driving ECU 3) executes reading of the previous processing result (previous value) of the third task from the third memory (global memory 54) without waiting for the processing result of the first task or the processing result of the second task.

The electronic system according to the second embodiment described above determines in advance that the previous value is continuously used in the subsequent processing in a case where the processing delay in the first electronic control device (camera ECU 1) that executes the preceding processing is large and does not meet the predetermined control cycle. As a result, in the present embodiment, there is an effect of preventing the mismatch of data (for example, data for generating the traveling trajectory 20) in the third electronic control device (automatic driving ECU 3).

### Third Embodiment

An electronic system and an electronic control device according to a third embodiment of the present invention will be described.

The third embodiment is different from the first embodiment in that a method of controlling another electronic control device (third electronic control device) that executes subsequent processing in a set control cycle is changed when a processing delay in the electronic control device (first electronic control device) that executes preceding processing becomes large. In the third embodiment, the same components as those of the first embodiment are denoted by the same reference numerals, and the description thereof will be omitted.

### <Recalculation of Scheduling>

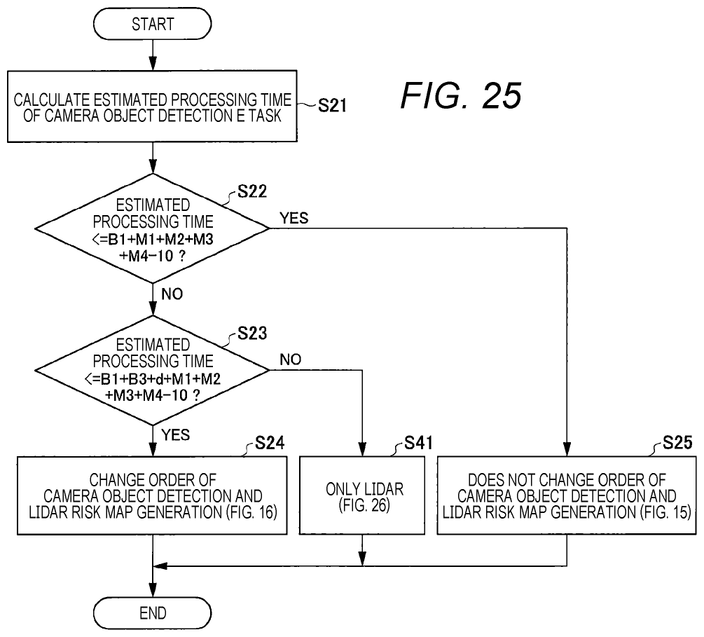

FIG. 25 is a flowchart for determining whether it is necessary to perform the change of the processing order in the third embodiment of the present invention. In FIG. 25, the processing of Step S41 is added as compared with FIG. 17.

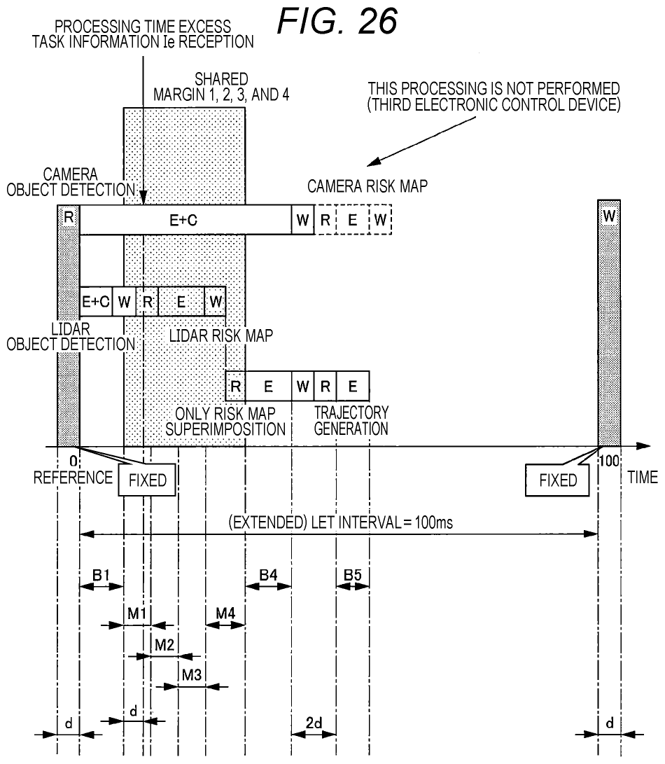

FIG. 26 is a diagram illustrating timing at which processing is performed by each electronic control device in a case where the processing is changed in the third embodiment. In FIGS. 25 and 26, portions different from those of the first embodiment will be mainly described.

In FIG. 25, in a case where the estimated processing time of the camera object detection E task exceeds “B1+B3+d+M1+M2+M3+M4−10” [ms] (NO in S23), the scheduling recalculation unit 82 changes the task scheduling so as not to generate the camera risk map but to generate only the LIDAR risk map 18 (see FIG. 26) (S41). In this case, the automatic driving ECU 3 generates the traveling trajectory 20 using the risk map 19 on which only the LIDAR risk map 18 is superimposed, and outputs the values of the various control commands 13 to 15.

In the present embodiment, only when YES is determined in Step S22, the scheduling recalculation unit 82 performs the processing of Step S25. That is, the scheduling recalculation unit 82 does not change the order of the camera object detection and the LIDAR risk map generation (see FIG. 15).

After the processing of Steps S24, S25, or S41, the processing of this flowchart is ended.

As described above, in the present embodiment, as in the first embodiment, the automatic driving ECU 3 determines the change of the execution order based on whether the estimated processing time of the camera object detection E task exceeds the maximum allowable processing time in the case where the execution order is not changed and is within the maximum allowable processing time in the case where the execution order is changed (S23).

Only when the estimated processing time exceeds the maximum allowable processing time in a case where the execution order is not changed and is within the maximum allowable processing time in a case where the execution order is changed (YES in S23), the automatic driving ECU 3 changes the execution order of the camera risk map generation R/E task and the LIDAR risk map generation R/E task as illustrated in FIG. 16 (S24).

However, when the estimated processing time exceeds the maximum allowable processing time in a case where the execution order is changed (NO in S23), the camera risk map generation is not performed. Then, only LIDAR risk map generation is performed, and trajectory generation processing is executed using only the risk map alone (S41).

Only when the estimated processing time is equal to or less than the maximum allowable processing time when the execution order is not changed (YES in S22), the execution order of each task is set as illustrated in FIG. 15 (no change in task scheduling) (S25).

### <Activation of Task in Third Electronic Control Device (Automatic Driving ECU)>

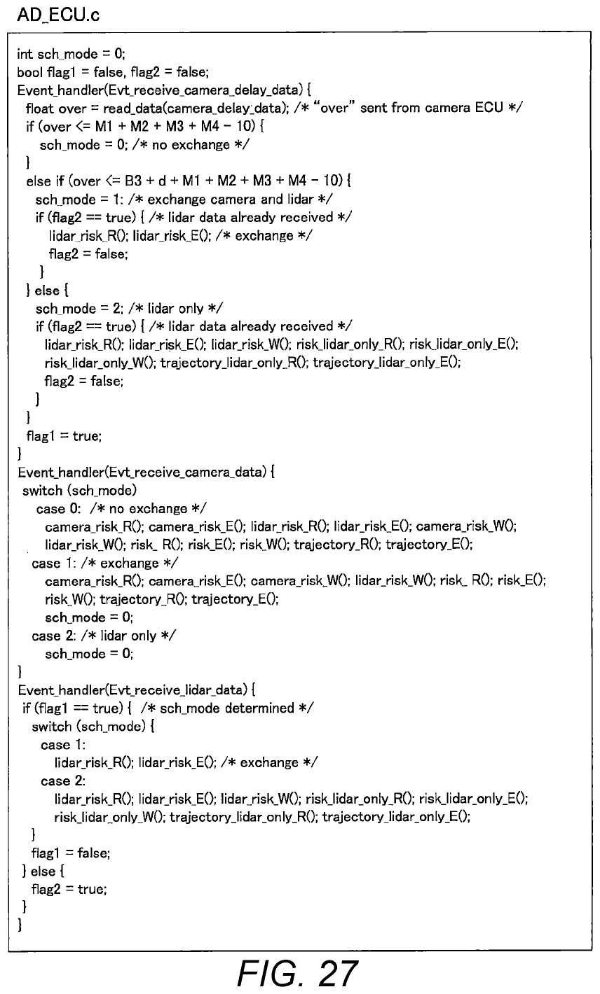

FIG. 27 is a diagram illustrating, by a source code, a method of activating a task in the third electronic control device (automatic driving ECU 3) according to the third embodiment.

When receiving the processing time excess task information Ie, the automatic driving ECU 3 receives the reception event notification and acquires the estimated excess time included in the processing time excess task information Ie, and sets the value of the variable sch_mode representing the scheduling mode to 1 when the estimated excess time exceeds “M1+M2+M3+M4−10” [ms] and is equal to or less than “B3+d+M1+M2+M3+M4−10” [ms]. Here, when the value of the estimated excess time exceeds “B3+d+M1+M2+M3+M4−10” [ms], the value of the variable sch_mode representing the scheduling mode is set to 2.

Thereafter, upon receiving the camera object detection data 10 from the camera ECU 1, the automatic driving ECU 3 receives the reception event notification of the data, and when the value of the variable sch_mode is 0 (default value), the automatic driving ECU 3 sequentially performs the camera risk map generation, the LIDAR risk map generation, the risk map superimposition, and the trajectory generation according to FIG. 15. Meanwhile, when the value of the variable sch_mode is 1, since the LIDAR risk map generation has already been previously executed when the camera object detection data 10 is received, the automatic driving ECU 3 sequentially performs the camera risk map generation, the risk map superimposition, and the trajectory generation, which are the remaining processing. Further, when the value of the variable sch_mode is 2, the automatic driving ECU3 does nothing (does not generate the camera risk map).

Upon receiving the LIDAR object detection data 12 from the LIDAR ECU 2, the automatic driving ECU 3 receives the reception event notification of the data, and does nothing when the value of the variable sch_mode is 0 (default value). When the value of the variable sch_mode is 1, the automatic driving ECU3 generates the LIDAR risk map. In addition, when the value of the variable sch_mode is 2, the automatic driving ECU3 performs the LIDAR risk map generation, the risk map superimposition, and the trajectory generation using only the LIDAR object detection data 12.

As described above, in the electronic system according to the third embodiment, based on the task activation order change command Cs, when the limit time is still exceeded even when the task (for example, the LIDAR risk map generation task) allocated to the third task processing is executed by the third task activation unit (task activation unit 83), the third task processing unit (automatic driving ECU3) executes the third task processing by activating the task (LIDAR risk map generation task) using only the processing result (LIDAR object detection data 12) of the second task by the third task activation unit (task activation unit 83) without waiting for the processing result (camera object detection data 10) of the first task.

In a case where the processing delay in the first electronic control device (camera ECU 1) that executes the preceding processing becomes large, the electronic system according to the third embodiment described above changes the control method in the control cycle. Accordingly, the present embodiment has an effect of enabling the third electronic control device (automatic driving ECU3) to observe the control cycle while using the latest value (for example, the LIDAR object detection data 12).

### Fourth Embodiment

An electronic system and an electronic control device according to a fourth embodiment of the present invention will be described.

The fourth embodiment is different from the third embodiment in that, in a case where a processing delay in an electronic control device (first electronic control device) that executes preceding processing becomes large, a control method of another electronic control device (third electronic control device) that executes subsequent processing in the control cycle is changed, and another processing is executed in an idle time generated within the control cycle by the change.

In the fourth embodiment, the same components as those of the third embodiment are denoted by the same reference numerals, and the description thereof will be omitted.

### <Recalculation of Scheduling>

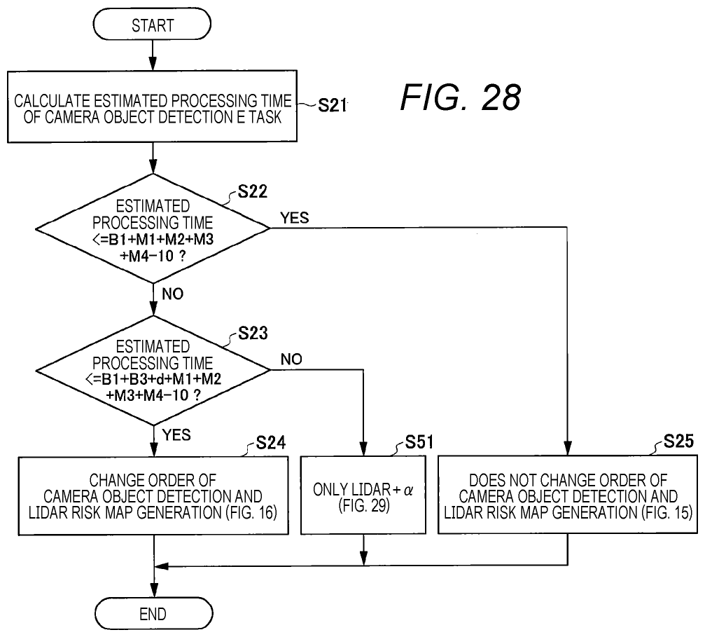

FIG. 28 is a flowchart for determining whether it is necessary to perform the change of the processing order in the fourth embodiment of the present invention. In FIG. 28, the processing in Step S51 is different from that in FIG. 25.

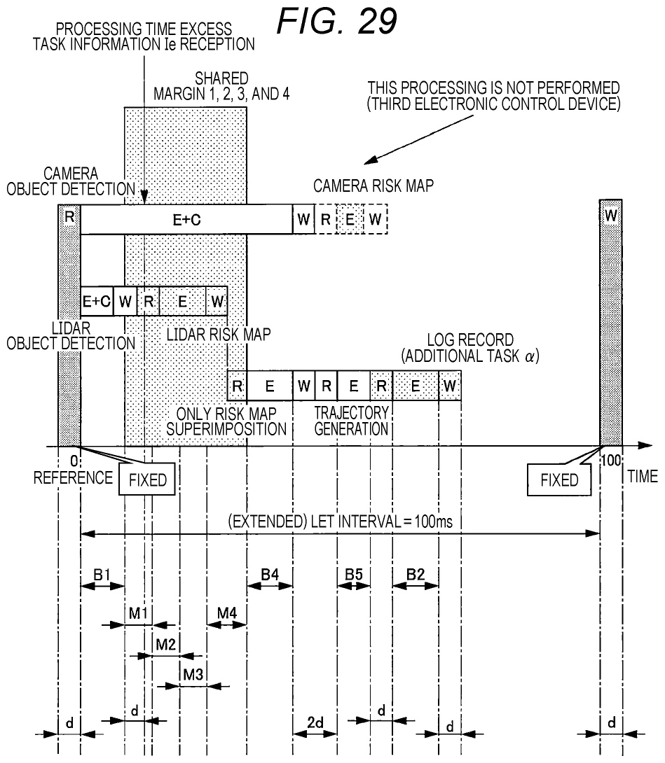

FIG. 29 is a diagram illustrating timing at which processing is performed by each electronic control device in a case where the processing is changed in the fourth embodiment. In FIGS. 28 and 29, portions different from those of the third embodiment will be mainly described.

In FIG. 28, in a case where the estimated processing time of the camera object detection E task exceeds “B1+B3+d+M1+M2+M3+M4−10” [ms] (NO in S23), the scheduling recalculation unit 82 changes the task scheduling such that the camera risk map generation is not performed and only the LIDAR risk map generation is performed. In the change of the task scheduling, the scheduling recalculation unit 82 determines that the automatic driving ECU3 executes the processing of generating the risk map 19 and generating the trajectory by using only the LIDAR risk map alone, and further executes log recording as an additional task x (as illustrated in FIG. 29) (S51).

Here, as illustrated in FIG. 10, the log recording task includes an R task, an E task, and a W task. In addition, a reference time (budget) which is an average execution time of a log recording E task is assumed to be the same as a budget B2 allocated to the camera risk map generation E task to be skipped. However, the reference time of the log recording E task may be equal to or less than the budget B2.

### <Activation of Task in Third Electronic Control Device (Automatic Driving ECU)>

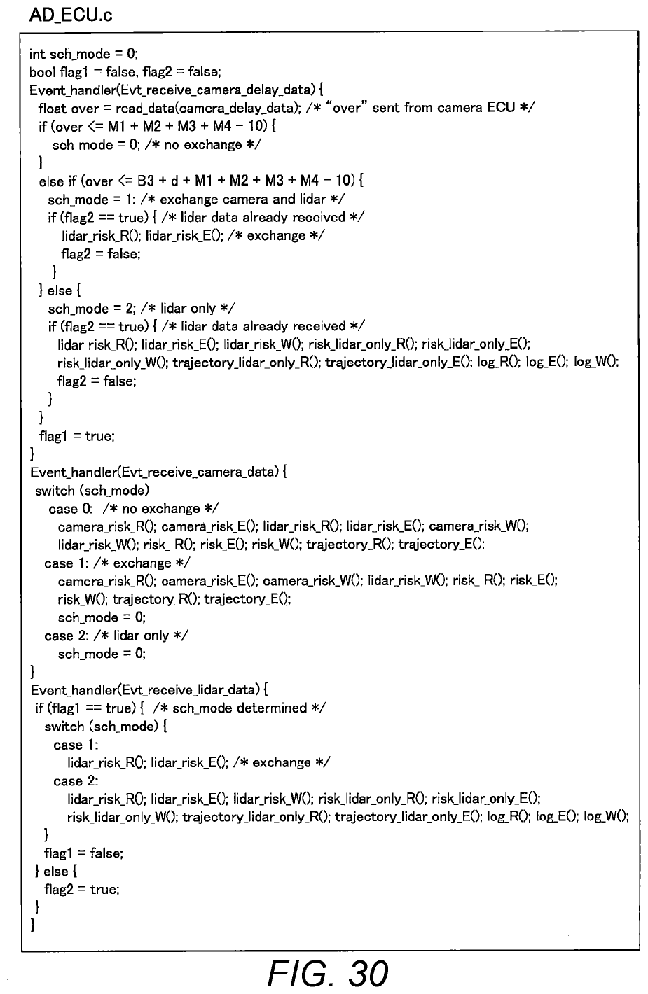

FIG. 30 is a diagram illustrating, by a source code, a method of activating a task in the third electronic control device (automatic driving ECU3) according to the fourth embodiment.

In the automatic driving ECU3, the condition for changing the value of the variable sch_mode representing the scheduling mode is the same as in the case of the third embodiment.

Upon receiving the LIDAR object detection data 12 from the LIDAR ECU 2, the automatic driving ECU3 receives the reception event notification of the data and does nothing when the value of the variable sch_mode is 0 (default value). When the value of the variable sch_mode is 1, the automatic driving ECU3 generates the LIDAR risk map. Furthermore, in a case where the value of the variable sch_mode is 2, the automatic driving ECU3 performs the LIDAR risk map generation, the risk map superimposition, and the trajectory generation using only the LIDAR object detection data 12, and further performs the log recording as additional processing.

As described above, in the electronic system according to the fourth embodiment, based on the task activation order change command Cs, when the limit time is still exceeded even when the task (for example, the LIDAR risk map generation task) allocated to the third task processing is executed by the third task activation unit (task activation unit 83), the scheduling recalculation unit (scheduling recalculation unit 82) generates the task activation order change command Cs so that the activation of the task (camera risk map generation task) using the processing result (camera object detection data 10) of the first task among the tasks allocated to the third task processing is stopped, and an arbitrary task (for example, log recording) whose execution ends within the processing time within the sum of the reference time of the stopped task and the used time margin is executed.

In a case where the processing delay in the first electronic control device (camera ECU 1) that executes the preceding processing becomes large, the electronic system according to the fourth embodiment described above changes the control method in the control cycle. As a result, in the present embodiment, the third electronic control device (automatic driving ECU3) can observe the control cycle while using the latest value (for example, the LIDAR object detection data 12). In addition, there is an effect that it is possible to improve the utilization efficiency of the CPU by executing another processing that falls within the reference time (budget) of the idle time caused by the change of the task scheduling.

### Fifth Embodiment

An electronic system and an electronic control device according to a fifth embodiment of the present invention will be described.

The fifth embodiment is different from the fourth embodiment in that when a processing delay in an electronic control device (first electronic control device) that executes preceding processing becomes large, a control method in the electronic control device (third electronic control device) that executes subsequent processing in the control cycle is changed, and another processing (corresponding to log recording in the fourth embodiment) to be executed in idle time caused by the change is determined in advance and distributed from the cloud. In the fifth embodiment, the same components as those of the fourth embodiment are denoted by the same reference numerals, and the description thereof will be omitted.

According to the fifth embodiment described above, in a case where the processing (function) is wirelessly distributed from the cloud to the electronic control device of the vehicle 100 by OTA (Over-The-Air), the processing (function) is distributed as long as the processing falls within the reference time (budget) that is the idle time under the condition that the distributed processing is executed. Therefore, there is an effect of ensuring that the distribution of the processing has no influence on all the calculation results of other processing (processing other than the distributed processing) executed in the electronic control device that receives the distribution.

### Sixth Embodiment

An electronic system and an electronic control device according to a sixth embodiment of the present invention will be described.

The sixth embodiment is different from the first embodiment in that a part of processing performed in an electronic control device (first electronic control device) is shifted to a cloud. In the sixth embodiment, the same components as those of the first embodiment are denoted by the same reference numerals, and the description thereof will be omitted.

### <Configuration>

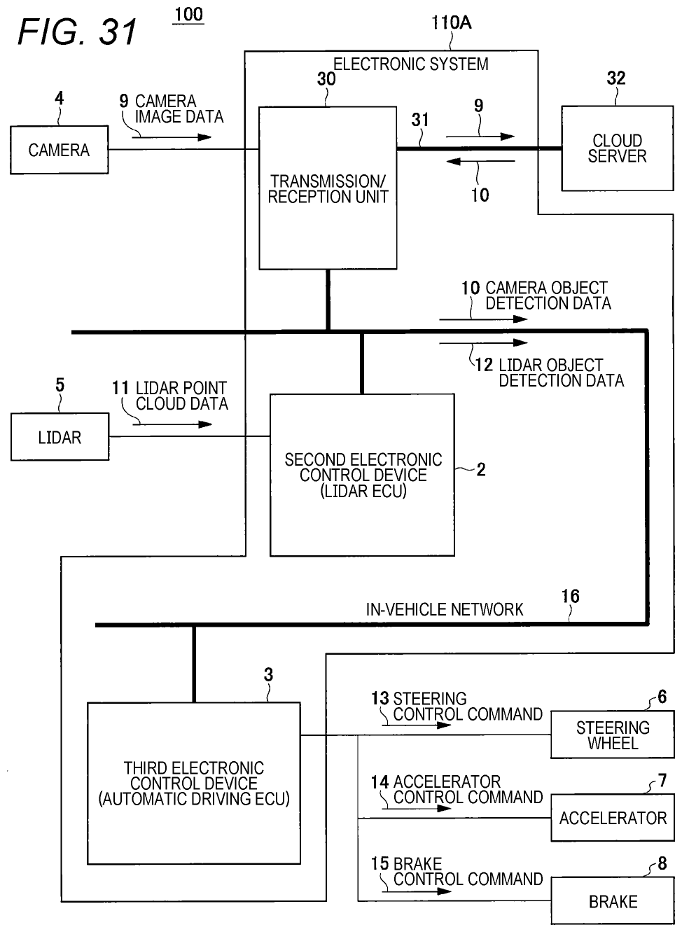

FIG. 31 is a diagram illustrating an overall configuration example of an electronic system according to the sixth embodiment of the present invention.

In an illustrated electronic system 110A, the wireless network 31 is used in parallel with the in-vehicle network 16. For the wireless network 31, a communication scheme exemplified by a wireless time sensitive network (WTSN) can be used. That is, the in-vehicle network 16 and the wireless network 31 are based on a communication scheme in which the times of all the electronic control devices (LIDAR ECU 2, automatic driving ECU3) connected to the in-vehicle network 16 and the wireless network 31, the cloud server 32, and other arithmetic devices (for example, CPUs) are synchronized, and data transmission is guaranteed within a certain period of time between the arithmetic devices.

The electronic system 110A includes a transmission/reception unit 30 instead of the camera ECU 1 (see FIG. 1) of the electronic system 110. The transmission/reception unit 30 is connected to the cloud server 32 (first electronic control device) via the wireless network 31. The transmission/reception unit 30 includes the configuration of the computer system (an example of a computer) illustrated in FIG. 2. However, the global memory 54 and the local memory 55 may be combined into one memory or may be deleted.

In the present embodiment, the second and third task processing units (the LIDAR ECU 2 and the automatic driving ECU3) are mounted on the vehicle 100, and the first task processing unit exists in the cloud server 32 outside the vehicle 100. The cloud server 32 can have a configuration similar to that of the computer system illustrated in FIG. 2. However, the input/output interface 56 may not be provided.

### <Operation>

The transmission/reception unit 30 receives the camera image data 9 from the camera 4, and transmits the camera image data 9 to the cloud server 32 (first electronic control device) via the wireless network 31.

The cloud server 32 has processing capability higher than that of the camera ECU 1. The electronic system 110A causes the cloud server 32 to execute the camera object detection data generation having a processing load larger than that of the LIDAR object detection data generation. The cloud server 32 executes the camera object detection R/E/W task, and transmits the camera object detection data 10 to the transmission/reception unit 30 through the wireless network 31. Then, the transmission/reception unit 30 transmits the camera object detection data 10 to the automatic driving ECU3 (third electronic control device) using the in-vehicle network 16.

As described above, in the electronic system according to the sixth embodiment, the first task processing (camera object detection task) and the second task processing (LIDAR object detection task) are executed in the same electronic control device (zone ECU 1B), and the third task processing (for example, each risk map generation task, risk map superimposition task, and the like) is executed in the electronic control device (automatic driving ECU3) different from the same electronic control device.

The electronic system according to the sixth embodiment described above has an effect of enabling dynamic change of the processing of the automatic driving ECU3 according to the situation of the processing (data generation and communication) on the cloud server 32 side while ensuring that the operation of the electronic system is not affected between the cloud server 32 and the vehicle 100.

### Seventh Embodiment

Next, an electronic system and an electronic control device according to a seventh embodiment of the present invention will be described.

The seventh embodiment is different from the first embodiment in that arithmetic devices of the first electronic control device (camera ECU 1) and the second electronic control device (LIDAR ECU 2) are integrated into one electronic control device. In the seventh embodiment, the same components as those of the first embodiment are denoted by the same reference numerals, and the description thereof will be omitted.

### <Configuration>

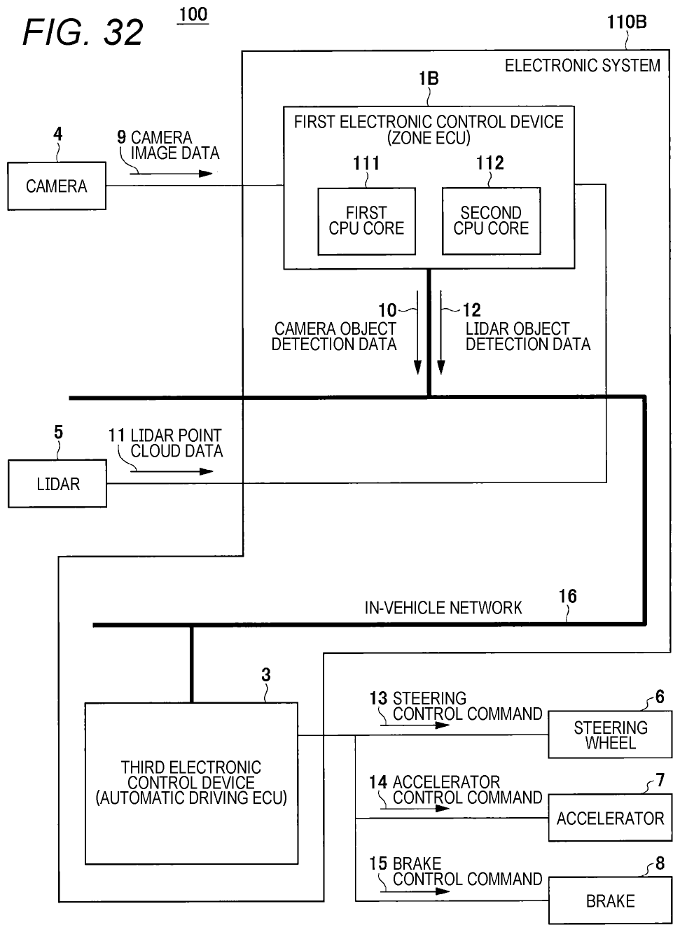

FIG. 32 is a diagram illustrating an overall configuration example of the electronic system according to the seventh embodiment of the present invention.

An illustrated electronic system 110B includes a zone ECU 1B (first electronic control device) and an automatic driving ECU3. The zone ECU 1B and the automatic driving ECU3 are connected by the in-vehicle network 16. The zone ECU 1B is an electronic control device that controls a function existing in an arbitrary zone of the vehicle 100 when the vehicle 100 is divided into a plurality of zones (ranges).

In the zone ECU 1B, both the camera object detection task and the LIDAR object detection task are processed.

The zone ECU 1B includes a first CPU core 111 and a second CPU core 112. Each of the CPU cores 111 and 112 corresponds to the CPU 51 in FIG. 2. For example, the zone ECU 1B includes the ROM 52, the RAM 53, the global memory 54, and the local memory 55 constituting the computer system illustrated in FIG. 2 for each of the first CPU core 111 and the second CPU core 112. In the zone ECU 1B, the input/output interface 56 and the network interface 57 may be common to the CPU cores 111 and 112 or may be provided for each of the CPU cores 111 and 112. The hardware configuration of the zone ECU 1B is an example, and is not limited to this example.

### <Operation>

The zone ECU 1B processes the camera object detection task in the first CPU core 111 and processes the LIDAR object detection task in the second CPU core 112. The first CPU core 111 receives the camera image data 9 from the camera 4, executes the camera object detection R/E/W task, and transmits the camera object detection data 10 to the automatic driving ECU3 using the in-vehicle network 16. In addition, the second CPU core 112 receives the LIDAR point cloud data 11 from the LIDAR 5, executes the LIDAR object detection R/E/W task, and transmits the LIDAR object detection data 12 to the automatic driving ECU3 using the in-vehicle network 16.

The electronic system 110B according to the seventh embodiment described above has the same effect as the electronic systems according to the first to fourth embodiments, and has an effect of reducing the number of electronic control devices to reduce the cost of hardware.

In the seventh embodiment, the electronic system 110B including the zone ECU 1B has been described, but the technology of the electronic system according to the seventh embodiment may be applied to an electronic system including an integrated ECU. The integrated ECU is an electronic control device that integrally controls a plurality of functions of the vehicle regardless of the zone of the vehicle 100. The integrated ECU may include only one CPU core instead of the plurality of CPU cores.

As described above, the electronic control device (automatic driving ECU3) according to the first to seventh embodiments is an electronic control device that is mounted on the vehicle and processes the plurality of tasks, and includes the electronic control device (for example, the camera ECU 1, the LIDAR ECU 2, the zone ECU 1B, and the like) different from the electronic control device or the arithmetic device (CPU 51) that executes task processing using a result processed in the cloud server 32. When a processing delay occurs in the different electronic control device or the cloud server, the arithmetic device receives information (processing time excess task information Ie) including the magnitude of the delay from the different electronic control device or cloud server, and performs control to change the order of task processing in the electronic control device using the received information.

Furthermore, the present invention is not limited to each of the above-described embodiments, and it goes without saying that various other application examples and modifications can be taken without departing from the gist of the present invention described in the claims. For example, the above-described embodiments describe the configurations of the electronic system and the electronic control device in detail and specifically in order to describe the present invention in an easy-to-understand manner, and are not necessarily limited to those including all the described components. In addition, a part of the configuration of one embodiment can be replaced with a component of another embodiment. In addition, components of other embodiments can be added to the configuration of one embodiment. In addition, it is also possible to add, replace, or delete other components for a part of the configuration of each embodiment.

In addition, some or all of the above-described configurations, functions, processing units, and the like may be realized by hardware, for example, by designing with an integrated circuit. A processor device in a broad sense such as a field programmable gate array (FPGA) or an application specific integrated circuit (ASIC) may be used as the hardware.

### REFERENCE SIGNS LIST

1 camera ECU
1B zone ECU
2 LIDAR ECU
3 automatic driving ECU
9 camera image data
10 camera object detection data
11 LIDAR point cloud data
12 LIDAR object detection data
16 in-vehicle network
17 camera risk map
18 LIDAR risk map
19 risk map
21 camera object detection task
22 LIDAR object detection task
23 camera risk map generation task
24 LIDAR risk map generation task
25 risk map superimposition task
26 trajectory generation task
30 transmission/reception unit
31 wireless network
32 cloud server
51 CPU
54 global memory
55 local memory
71 scheduling unit
72 task activation unit
73 task processing time management unit
74 data transmission/reception unit
81 scheduling unit
82 scheduling recalculation unit
83 task activation unit
84 data transmission/reception unit
100 vehicle
110, 110A, 110B electronic system
B budget
M margin
Ie processing time excess task information
Cs task activation order change command

1. An electronic system comprising a plurality of task processing units that process an assigned task are connected via a network, wherein
each of the plurality of task processing units includes a task activation unit that activates and executes the task, and
third task processing in a third task processing unit uses at least a processing result of a first task in a first task processing unit or a processing result of a second task in a second task processing unit preceding the third task processing, and periodically executes a series of processing from the preceding first task processing or the second task processing to the third task processing at predetermined time intervals.

2. The electronic system according to claim 1, wherein
at least the first task processing unit includes a processing time management unit that manages a processing time of the activated first task, and
in the processing time management unit, when the time required for the first task processing exceeds a predetermined time, processing time excess task information including information related to a time at which the task processing is estimated to end is generated and transmitted to the third task processing unit via the network.

3. The electronic system according to claim 2, wherein
the third task processing unit includes a scheduling recalculation unit that recalculates a processing schedule of the third task processing unit based on the received processing time excess task information,
the scheduling recalculation unit generates a task activation order change command in the third task processing unit by recalculation and transmits the task activation order change command to a third task activation unit included in
the third task processing unit, and
the third task activation unit changes a task activation order based on the task activation order change command.

4. The electronic system according to claim 3, wherein
each task processing unit includes a memory to read information necessary for execution of the task and write a processing result of the task,
the predetermined time interval is a limit time from a timing at which information necessary for execution of the first or second task is read from a first or second memory to a timing at which a processing result of the third task is written to a third memory, and
the limit time is fixed in advance.

5. The electronic system according to claim 4, wherein
the limit time includes a reference time that is an average execution time of the task and a time margin, and
the time margin is used in processing of a corresponding task when an execution delay occurs in any of the first task, the second task, and the third task.

6. The electronic system according to claim 5, wherein
the third task includes a task that uses a processing result of the first task and a task that uses only a processing f the second task without using the processing result of the first task, and
when the first task processing exceeds the predetermined reference time among the tasks allocated to the third task processing, the third task activation unit activates a task that uses only the processing result of the second task without using the processing result of the first task in advance based on the task activation order change command of the scheduling recalculation unit.

7. The electronic system according to claim 6, wherein
when the first task processing ends within the predetermined reference time with respect to the first task processing, the third task activation unit first activates a task that uses the processing result of the first task and then activates a task that uses the processing result of the second task, and
when the first task processing exceeds the reference time and a time estimated to end the first task processing included in the processing time excess task information is a value equal to or less than a sum of the reference time, the used time margin, and a predetermined reference time for the second task processing, the third task activation unit first activates the task that uses only the processing result of the second task and then activates the task that uses the processing result of the first task.

8. The electronic system according to claim 6, wherein in a case where the limit time is still exceeded even when the task allocated to the third task processing is executed by the third task activation unit based on the task activation order change command, the third task processing unit reads a previous processing result of the third task from the third memory without waiting for the processing result of the first task or the processing result of the second task.

9. The electronic system according to claim 6, wherein in a case where the limit time is still exceeded even when the task allocated to the third task processing is executed by the third task activation unit based on the task activation order change command, the third task processing unit executes the third task processing by activating the task that uses only the processing result of the second task by the third task activation unit without waiting for the processing result of the first task.

10. The electronic system according to claim 6, wherein in a case where the limit time is still exceeded even when the task allocated to the third task processing is executed by the third task activation unit based on the task activation order change command, the scheduling recalculation unit generates the task activation order change command so as to stop activation of the task that uses the processing result of the first task among the tasks allocated to the third task processing and execute an arbitrary task whose execution ends within a processing time within a sum of a reference time of the stopped task and the used time margin.

11. The electronic system according to claim 6, wherein the first, second, and third task processing units are electronic control devices, and are each mounted on a vehicle.

12. The electronic system according to claim 6, wherein
the second and third task processing units are electronic control devices mounted on a vehicle, and
the first task processing unit is present in a cloud server outside the vehicle.

13. The electronic system according to claim 5, wherein a time at which the task processing is estimated to end is calculated based on a progress rate of the task processing when the reference time of the task processing is exceeded.

14. The electronic system according to claim 1, wherein
the processing result of the first task and the processing result of the second task are processing results of data obtained from a sensing device, and
the third task processing unit controls driving of the vehicle using the processing result of the first task and/or the processing result of the second task.

15. The electronic system according to claim 1, wherein
the first task processing and the second task processing are executed in a same electronic control device, and
the third task processing is executed in an electronic control device different from the same electronic control device.

16. An electronic control device that is mounted on a vehicle and processes a plurality of tasks, the electronic control device comprising an arithmetic device that executes task processing using a result processed in an electronic control device or a cloud server different from the electronic control device, wherein
when a processing delay occurs in the different electronic control device or the cloud server, the arithmetic device receives information including a magnitude of the delay from the different electronic control device or the cloud server, and performs control to change an order of task processing in the electronic control device using the received information.
